(19) United States
(12) Patent Application Publication
(10) Pub. No.: US 2016/0297560 A1
(43) Pub. Date: Oct. 13, 2016

(54) CARTON AND BLANK FOR PRODUCING VARIOUS CARTONS AND METHODS OF USING SUCH CARTONS

(71) Applicant: Zsolt TOTH, Tuckahoe, NY (US)

(72) Inventor: Zsolt TOTH, Tuckahoe, NY (US)

(21) Appl. No.: 15/022,118

(22) PCT Filed: Sep. 21, 2015
(86) PCT No.: PCT/US15/51222

§ 371 Date: Mar. 15, 2016

Related U.S. Application Data
(60) Provisional application No. 62/053,327, filed on Sep. 22, 2014.

(30) Foreign Application Priority Data
Dec. 12, 2014 (CA) 2874260

(51) Int. Cl. B65D 5/00; B65D 5/42; B31B 1/76; B65D 5/08

(52) U.S. Cl. CPC B65D 5/001; B65D 5/08; B65D 5/4266; B31B 1/76; B31B 2201/28

(57) ABSTRACT

An improved blank for producing a carton, the carton and methods of using such cartons utilize continuous closure panels. The blank provides the carton with one or more of a top continuous closure panel which can flex to permit carton stacking, an interlocking bottom continuous closure panel which remains in closed condition when the carton is moved without requiring taping, gluing, stapling or other assistance, and a top continuous closure panel with fold lines enabling folding the top continuous closure panel to different heights.

### TECHNICAL FIELD

The present invention is directed to an improved blank for producing an improved carton and an improved carton erected therefrom. The invention is particularly suited for, but not limited to, corrugated blanks and cartons. Thus, while the following description and drawings make reference to corrugate blanks and cartons, the invention is applicable to blanks and cartons of other materials.

### BACKGROUND

U.S. Pat. Nos. 6,467,682; 6,668,525; 6,886,311 and 6,951,530 disclose a carton, a blank for producing a carton, and methods and apparatus for erecting, closing and sealing a carton. The blank for erecting a carton has fold-in panels that include 180° fold lines with a compressed area at each end and a straight slit joining the compressed areas. A carton is erected by moving the blank in a first direction against a stop to form a first set of 90° folds, holding the blank stationary with a suction while pushing the blank in a second direction to form a second set of 90° folds, erecting the carton. A filled carton is closed by advancing it through the central opening of a V-shaped member to increasingly fold the continuous closure panel formed by the carton top panels. The closed carton is sealed by advancing it through a second V-shaped member and into contact with a pivotally supported sealing device. The disclosures of the aforementioned U.S. patents are hereby incorporated by reference.

An example of this known carton blank 30 from which a carton can be erected as shown in FIG. 1. Blank 30 includes a first side panel 32 having a first end edge 34, a second end edge 36, a top edge 38 and a bottom edge 40. End edges 34 and 36 are substantially parallel with each other, while top edge 38 and bottom edge 40 are substantially parallel with each other and substantially perpendicular to edges 34 and 36. Blank 30 further includes a first end panel 42 having a first side edge 44, a second side edge 46, a top edge 48, and a bottom edge 50. Carton blank 30 also includes a second side panel 52 having a first end edge 54, a second end edge 56, a top edge 58, and a bottom edge 60. Carton 30 further includes a second end panel 62 having a first side edge 64, a second side edge 66, a top edge 68, and a bottom edge 70. Edges 46, 54, 56, 64 and 66 are substantially parallel with edge 34, while edges 48, 58, and 68 are extensions of edge 38, and edges 50, 60, and 70 are extensions of edge 40.

Carton blank 30 also includes a first top panel 72 having a first side edge 74, a second side edge 76, a first end edge 78, and a second end edge 80. Edges 74 and 76 are substantially parallel with edge 38, and edges 78 and 80 are extensions of edges 34 and 36, respectively. Carton blank 30 includes a first bottom panel 82 having a first side edge 84, a second side edge 86, a first end edge 88, and a second end edge 90. Edges 84 and 86 are substantially parallel with edge 38, while edges 88 and 90 are extensions of edges 34 and 36, respectively. Carton blank 30 also includes a first fold-in panel 92 having a first end edge 94, a second end edge 96, a first side edge 98, and a second side edge 100. Edges 94 and 96 are extensions of edges 74 and 76, respectively, while edges 98 and 100 are extensions of edges 44 and 46, respectively. Carton blank 30 has a second fold-in panel 102 having a first end edge 104, a second end edge 106, a first side edge 108, and a second side edge 110. Edges 104 and 106 are extensions of edges 84 and 86 respectively, while edges 108 and 110 are extensions of edges 44 and 46, respectively. Carton blank 30 includes a second top panel 112 having a first side edge 114, a second side edge 116, a first end edge 118, and a second end edge 120. Edges 114 and 116 are extensions of edges 94 and 96, respectively, while edges 118 and 120 are extensions of edges 54 and 56, respectively. Carton blank 30 includes a second bottom panel 122 having a first side edge 124, a second side edge 126, a first end edge 128, and a second end edge 130. Edges 124 and 126 are extensions of edges 104 and 106, respectively, while edges 128 and 130 are extensions of edges 54 and 56, respectively. Carton blank 30 additionally includes a third fold-in panel 132 having a first end edge 134, a second end edge 136, a first side edge 138, and a second side edge 140. Edges 134 and 136 are extensions of edges 114 and 116, respectively, while edges 138 and 140 are extensions of edges 64 and 66, respectively. Carton blank 30 includes a fourth fold-in panel 142 having a first end edge 144, a second end edge 146, a first side edge 148 and a second side edge 150. Edges 144 and 146 are extensions of edges 124 and 126, respectively, while edges 148 and 150 are extensions of edges 64 and 66, respectively. First end panel 42 extends from first side panel 32, with first side edge 44 joined to second end edge 36 to define a 90° fold line. Second side panel 52 extends from first end panel 42, with first end edge 54 joined to second side edge 46 to define a 90° fold line. Second end panel 62 extends from second side panel 52, with first side edge 64 joined to second end edge 56 to define a 90° fold line. Sealing strip 154 extends from second end panel 62, with side edge 66 joined to sealing strip 154 to define a 90° fold line. First top panel 72 extends from first side panel 32, with first side edge 74 joined to top edge 38 to define a 90° fold line. First bottom panel 82 extends from first side panel 32, with first side edge 84 joined to bottom edge 40 to define a 90° fold line. First fold-in panel 92 extends from first end panel 42, with first end edge 94 joined to top edge 48 to define a 90° fold line and said fold-in panel 92 extends from first top panel 72 with first side edge 98 joined to second end edge 80 to define a 180° fold line. Second fold-in panel 102 extends from first end panel 42, with first end edge 104 joined to bottom edge 50 to define a 90° fold line and said fold-in panel 102 extends from first bottom panel 82 with first side edge 108 joined to second end edge 90 to define a 180° fold line. Second top panel 112 extends from second side panel 52, with first side edge 114 joined to top edge 58 to define a 90° fold line and said top panel 112 extends from first fold-in panel 92 with first end edge 118 joined to second side edge 100 to define a 180° fold line. Second bottom panel 122 extends from second side panel 52, with first side edge 124 joined to bottom edge 60 to define a 90° fold line and said bottom panel 112 extends from second fold-in panel 102 with first end edge 128 joined to second side edge 110 to define a 180° fold line. Third fold-in panel 132 extends from second end panel 62, with first end edge 134 joined to top edge 68 to define a 90° fold line and said fold-in panel 132 extends from second top panel 112 with first side edge 138 joined to second end edge 120 to define a 180° fold line. Fourth fold-in panel 142 extends from second end panel 62, with first end edge 144 joined to bottom edge 70 to define a 90° fold line and said fold-in panel 142 extends from second bottom panel 122 with first side edge 148 joined to second end edge 130 to define a 180° fold line. Sealing strip 154 extends from third folding panel 132, with side edge 140 joined to sealing strip 154 to define a 180° fold line and said sealing strip 154 extends from fourth folding panel 142, with side edge 150 joined to sealing strip 154 to define a 180° fold line. Each fold-in panel 92, 102, 132, and 142 includes a pair of 180° fold lines 152 which extend from a point on the second end edge 96, 106, 136, 146, of the respective panel substantially midway between the first and second side edges of such panel to respective ones of points at the intersections of the first end edge 94, 104, 134, 144 of the respective panel and the first and second side edges of such panel. The carton blank 30 in the example also includes a sealing strip 154 extending from third fold-in panel 132, second end panel 62, and fourth fold-in panel 142 as depicted in FIG. 1. Sealing strip 154 includes fold lines which are extensions of the 90° fold lines defined by edges 68 and 134 and edges 70 and 144 and which are extensions of the 180° fold lines defined by edges 68 and 136 and edges 70 and 146. After carton blank 30 has been manufactured, it is folded 180° on the fold line defined by edges 46, 54, 100, 110, 118, and 128, and sealing strip 154 is sealed to panels 72, 32, and 82, forming the folded carton blank as depicted in FIG. 12 of the aforementioned U.S. patents. Alternatively, sealing strip 154 can be omitted, and panels 132, 62, and 142 sealed to panels 72, 32, and 82 by other means such as a sealing tape. Further, instead of making the folded carton blank in one piece, it can be made in two pieces which are then sealed together, as discussed below with regard to FIG. 11.

FIGS. 2-5 show the form of the 180° fold lines of the known carton blank. Each 180° fold line includes first and second compressed areas 156 which extend from opposite ends of the 180° fold line for a distance of about two inches and which are joined by a straight slit 158. Each compressed area 156 is preferably oval in shape with a maximum width of from about ⅜ inch to about ½ inch for standard packing carton corrugated panels. As can be seen in FIG. 3, each compressed area 156 extends into the material of carton blank 30 a substantial distance, while leaving the adjacent panel portions joined. A protrusion 160 extends from the undersurface of carton blank 30, substantially along the center line of each compressed area 156 to define a fold line. As can be seen in FIG. 4, each slit 158 extends through carton blank 30.

FIG. 5 illustrates the manner in which carton blank 30 can be folded 180° as a result of the 180° fold lines formed by compressed areas 156 and slits 158. As can be seen in FIG. 5, as a result of compressed areas 156, the 180° fold is readily made without unduly stressing the carton blank material.

FIGS. 6-10 illustrate the manner in which a carton 162 formed from carton blank 30 can be closed after the carton has been erected and filled. In FIG. 6, carton 162 is illustrated with top panels 72 and 112 and first and third fold-in panels 92 and 132 extending upwardly from their corresponding side panels and end panels together forming a continuous closure panel. FIG. 7 illustrates carton 162 when fold-in panels 92 and 132 are initially folded in on 180° fold lines 152. Top panels 72 and 112 are folded partially together. FIG. 8 depicts carton 162 with the fold-in panels 92 and 132 further folded in and with top panels 72 and 112 folded closer together. FIG. 9 illustrates carton 162 fully closed. FIG. 10 shows the closed carton 162 with top panels 72 and 112 sealed together, by a sealing tape 164. Carton 162 can be closed and sealed with the method and apparatus disclosed in the aforementioned U.S. patents or, if desired, carton 162 can be closed and sealed, as well as erected, manually. Manual erecting and closing of carton 162 can be done rapidly by simply pressing on any one of the bottom panels to erect the carton and any one of the top panels to close the carton. Pressing on any one of the bottom panels or of the top panels causes all of the bottom panels or the top panels to fold in an inward direction, closing the bottom or the top.

Instead of the single piece carton blank 30 of FIG. 1, the carton blank can be formed of two blanks 169 as illustrated in FIG. 11. The two blanks 169 are then positioned one over the other, with one rotated 180° with respect to the other, and the sealing strip of each blank is sealed to the other blank. This construction provides a carton blank 30 just as illustrated in FIG. 12 of the aforesaid U.S. patents.

FIG. 12 depicts another form of carton 162b having a strip 212 of sealing tape affixed to top panel 112 so that when top panels 72 and 112 are closed, the strip will adhere to panel 72, sealing the carton. With this feature, a sealing apparatus is not necessary.

It has been found that wherein (1) the top continuous closure panel of cartons erected from these known carton blanks is in open and upright position, said top continuous closure panel cannot be flexed in an outward direction on the top edge to enable cartons formed from the same carton blank to be inserted one into the other to create a stack of cartons; and wherein the known carton blank is made of corrugated board material thicker than single-ply, said top and bottom continuous closure panels of said carton erected from said blank have a tendency to resist quick and easy carton erection or carton closure; and further, it has been found wherein (2) cartons erected from these known carton blanks have a bottom continuous closure panel in closed condition, said bottom continuous closure panel does not remain in closed condition without need of additional fastening such as taping, gluing, stapling or other means of fastening and sealing the closed bottom continuous closure panel when said carton is moved; and further, it has been found wherein (3) the known carton blank is limited to forming cartons from said blank so that when said cartons are in erected condition, said cartons can be closed to only one height as determined by the top edge.

There is a need for improved carton blanks for forming improved cartons of the above-described types that avoids the drawbacks of the known carton blank and known carton.

### DESCRIPTION OF THE INVENTION

It has been found that when cartons formed from the known carton blank are in erected condition according to the known invention, the closed bottoms of said known cartons cannot be inserted into the open top of another said known carton formed from the same said known carton blank, therefore preventing achieving the advantage of inserting cartons one inside the other to create a stack of cartons without limit as to the height of the stack to free valuable floor space; further, it has been found that when said known cartons are formed from said known carton blank wherein said carton blank is made of corrugated board material thicker than single-ply material, resistance to said known carton erection and carton closure increases according to the thickness of the corrugated board material of said known carton blank and said known carton formed therefrom. There is a need for an improved carton blank for forming an improved carton therefrom that avoids carton stacking, erection and closure drawbacks as described herein of the known carton blank and known carton.

The disclosed example embodiment of a first aspect (1) of the present invention described herein addresses the aforementioned carton stacking need by providing an improved carton blank for forming an improved carton erected therefrom wherein any style new top flexible continuous closure panels of said improved carton when in erected condition flex in an outward direction on the top edge of said improved carton to enable the bottom of said improved erected carton to be inserted into the open top of another said improved erected carton, both said improved cartons formed from the same said improved carton blank, to enable said improved erected cartons to be inserted one into another to create a stack of said improved cartons without limit to the height of the stack. The advantage of inserting the closed bottom of said improved erected carton into the open top of another said improved erected carton, both said improved cartons formed from the same said improved carton blank, is attained according to the feature of the improved carton blank and improved carton erected therefrom wherein the any style new top flexible continuous closure panel has one improved fold-in panel with said improved fold-in panel joined on its second side edge to said top panel first end edge with each said improved fold-in panel having one transverse 180° fold line. The first aspect (1) of the present invention also addresses the aforementioned need for quick and easy carton erection and closure by providing an improved carton blank of the type described herein for forming an improved carton wherein any style new flexible continuous closure panel reduce resistance of carton erection or closure regardless of the thickness of the corrugated board material. The advantage of quick and easy carton erection or closure regardless of thickness of corrugated board material is attained according to the feature of said improved carton blank and said improved carton formed therefrom wherein said improved carton blank has new top flexible continuous closure panel and new bottom flexible continuous closure panel with each said new top flexible continuous closure panel having one improved fold-in panel with said improved fold-in panel joined on its second side edge to the top panel first end edge, and wherein said improved fold-in panel has one transverse 180° fold line, with said new bottom flexible continuous closure panel having one improved fold-in panel with said improved fold-in panel joined on its second side edge to the bottom panel first end edge, and with said improved fold-in panel having one transverse 180° fold line.

Further, it has been found that when cartons formed from the known carton blank are in erected condition according to the known invention, when said known carton is moved, the bottom continuous closure panel of said known carton does not remain in closed condition without need of additional fastening such as taping, gluing, stapling or other means of fastening and sealing the closed bottom continuous closure panel when said known carton is moved. There is a need for an improved carton blank for forming an improved carton therefrom that avoids the drawbacks as described herein of the known carton blank and known carton.

The disclosed example embodiment according to a second aspect (2) of the present invention described herein addresses the aforementioned need for the closed bottom interlocking continuous closure panel of an erected carton to remain in closed condition without requiring taping, gluing, stapling or other assistance when said carton is moved. The advantage of a carton in erected condition having a bottom interlocking continuous closure panel in closed condition that remains in closed condition when said carton is moved is attained according to the feature of the improved carton blank and improved carton erected therefrom wherein the improved bottom interlocking continuous closure panel has two new fold-in panels with each said new fold-in panel having two notches that create a shape such as, but not limited to, an isosceles trapezoid in said new fold-in panels, and wherein said improved bottom interlocking continuous closure panel has two new bottom panels with each said new bottom panel having two notches that create a shape such as, but not limited to, an isosceles trapezoid in said new bottom panels, wherein said notches of said two new bottom panels and of said two new fold-in panels of said improved bottom interlocking continuous closure panel interlock together, so that when said improved erected carton is moved, said improved closed bottom interlocking continuous closure panel remains in closed condition without need of additional fastening such as taping, gluing, stapling or other means of fastening and sealing said improved closed bottom interlocking continuous closure panel.

Further, it has been found that the known carton blank forms cartons that when said known cartons are in erected condition according to the known invention, said known cartons can be closed to only one height as defined by the top edge of the known carton blank. There is a need for an improved carton blank for forming an improved carton therefrom that avoids the drawbacks described herein of the known carton blank and carton.

The disclosed example embodiment according to a third aspect (3) of the present invention described herein addresses the aforementioned need for an improved carton blank and improved carton formed therefrom wherein said improved carton can be closed to one of two different heights. The advantage of said improved carton that can be closed to one of two different heights is attained according to the feature of an improved carton blank wherein an improved top variable height continuous closure panel has fold lines to enable folding said improved top variable height continuous closure panel on said fold lines to close said improved carton at its higher height, and wherein said improved top variable height continuous closure panel has edges to enable folding said top variable height continuous closure panel on said edges to close said improved carton at its lower height.

These and other features and advantages of the present inventions described herein will become more apparent from the following detailed description and claims, particularly when considered in conjunction with the accompanying drawings in which like parts bear reference numerals.

### BRIEF DESCRIPTION OF DRAWINGS

FIG. 1 depicts a prior art carton blank as disclosed in the aforementioned U.S. patents;

FIG. 2 is an enlarged fragmentary view of area 5-5 of FIG. 1;

FIG. 3 is a sectional view taken on line 6-6 of FIG. 2;

FIG. 4 is a sectional view taken on line 7-7 of FIG. 2;

FIG. 5 is a fragmentary view of a 180° fold as made in a prior art carton blank of the aforementioned U.S. patents;

FIGS. 6-10 depict a prior art carton of FIGS. 1-5 in various degrees of closing;

FIG. 11 depicts another known carton blank in accordance with the aforementioned U.S. patents;

FIG. 12 depicts an alternative form of a known carton in accordance with the aforementioned U.S. patents;

FIG. 13 depicts yet another improved carton blank as disclosed in the aforementioned U.S. patents;

FIG. 14 is an enlarged fragmentary view of area 9-9 of FIG. 13;

FIG. 15 is a still further enlarged fragmentary view of a portion of the carton blank shown in FIG. 14 showing the C-shaped cut extending between the first and second compressed areas of each transverse 180° fold lines of the fold-in panel;

FIG. 16 is a perspective view from a side and above of an erected, partially closed carton erected using the carton blank of FIGS. 13-15;

FIGS. 17A-17C are schematic illustrations of a portion of the carton of FIG. 16 as the top closure panel thereof is progressively closed (FIG. 17A) to a point of equilibrium (FIG. 17B) and then to a point past equilibrium (FIG. 17C) where the fold-in panels maintain closure in accordance with the invention.

FIG. 18 is a top view of a carton blank depicting new top and new bottom Style A flexible continuous closure panels in accordance with a first aspect (1) of the present invention;

FIG. 19A is an enlarged sectional view of area AA depicted in FIG. 18;

FIG. 19B depicts alternative forms of the new fold-in panel depicted in FIG. 19A wherein the fold-in panel has a fold control notch.

FIG. 20A is an enlarged fragmentary view of area BB depicted in FIG. 18;

FIG. 20B depicts an alternative form of the new fold-in panel depicted in FIG. 20A wherein the fold-in panel has a fold control notch.

FIG. 21A is the top view of the folded and glued carton flat formed from the carton blank depicted in FIG. 18;

FIG. 21B is the bottom view of the folded and glued carton flat formed from carton blank depicted in FIG. 18;

FIG. 22 is a perspective view from a side and above of an erected, fully open carton with new Style A flexible continuous closure panels flexing in an outward direction, said erected carton formed from the carton flat depicted in FIGS. 21A and B in accordance with the first aspect (1) of the present invention;

FIG. 23 is a perspective view from a side and above of three erected, fully open cartons stacked one inside the other using the erected cartons depicted in FIG. 22;

FIG. 24 is a perspective view from a side and above of the new top Style A flexible continuous closure panel in fully open and upright condition, the erected carton depicted in FIG. 24 is formed from carton blank depicted in FIG. 18;

FIGS. 25 and 26 depict the progressive closing of the erected carton depicted in FIG. 24, with FIG. 25 depicting the new top Style A flexible continuous closure panel now in partially closed condition, and with FIG. 26 depicting the new top Style A flexible continuous closure panel now in fully closed condition, said erected carton now in fully closed condition in accordance with the first aspect (1) of the present invention;

FIG. 27 is a top view of another carton blank depicting one new Style B flexible continuous closure panel in accordance with first aspect (1) of the present invention;

FIG. 28 is an enlarged sectional view area CC depicted in FIG. 27;

FIG. 29 is a perspective view from a side and above of the new top Style B flexible continuous closure panel with the first top panel in fully open and upright condition, the erected carton depicted in FIG. 29 is formed from carton blank depicted in FIG. 27;

FIGS. 30 and 31 depict the progressive closing of the erected carton depicted in FIG. 29, with FIG. 30 depicting part of the new top Style B flexible continuous closure panel now in fully closed condition, and the first top panel remaining in fully open and upright position, and with FIG. 31 depicting the new top Style B flexible continuous closure panel and the first top panel both now in fully closed condition, said erected carton now in fully closed condition in accordance with the first aspect (1) of the present invention;

FIG. 32 is a top view of yet another carton blank depicting new top Style C flexible continuous closure panel in accordance with the first aspect (1) of the present invention;

FIG. 33 is an enlarged sectional view of area DD depicted in FIG. 32;

FIG. 34 is a perspective view from a side and above of the new top Style C flexible continuous closure panel in fully open and upright condition, the erected carton depicted in FIG. 34 is formed from carton blank depicted in FIG. 32;

FIGS. 35 and 36 depict the progressive closing of the erected carton depicted in FIG. 34, with FIG. 35 depicting part of new top Style C flexible continuous closure panel now in fully closed condition and the other part of top new Style C flexible continuous closure panel remaining in fully open and upright position, and with FIG. 36 depicting the new top Style C flexible continuous closure panel now in fully closed condition, said erected carton now in fully closed condition in accordance with the first aspect (1) of the present invention;

FIG. 37 is a top view of yet another carton blank showing the improved bottom interlocking continuous panel in accordance with the second aspect (2) of the present invention;

FIG. 38A is an enlarged fragmentary view of area EE depicted in FIG. 37;

FIG. 38B depicts an alternative form of the new bottom panel depicted in FIG. 38A;

FIG. 38C depicts yet another alternative form of the new bottom panel depicted in FIG. 38B wherein the new bottom panel does not have a notch edge;

FIG. 38D depicts an alternative form of the new bottom panel depicted in FIG. 38A wherein the notch edge and the locking edge are replaced by a fully or partly cut oval shape;

FIG. 38E depicts yet another alternative form of the new bottom panel depicted in FIG. 38C wherein the bottom panel has only one locking edge;

FIG. 39A is an enlarged fragmentary view of area FF depicted in FIG. 37;

FIG. 39B depicts an alternative form of the new fold-in panel depicted FIG. 39A;

FIG. 39C depicts an alternative form of the new fold-in panel depicted FIG. 39B wherein the new fold-in panel has only one locking edge;

FIG. 40 depicts the top view of folded and glued carton flat formed from carton blank depicted in FIG. 37;

FIG. 41 depicts the carton flat depicted in FIG. 40 with said flat oriented in FIG. 41 with top continuous closure panel on the bottom and new bottom interlocking continuous closure panel on the top;

FIG. 42 depicts the carton flat depicted in FIG. 41 in squared condition with a perspective view from a side and above of the new bottom interlocking continuous closure panel in fully open and upright condition and the top continuous closure panel in fully open condition, said flat formed from the carton blank depicted in FIG. 37;

FIGS. 43-49 depict the progressive closing and interlocking of the bottom continuous closure panel of the squared flat depicted in FIG. 42, with FIG. 43 depicting the improved fold-in panels beginning to be pulled or pushed in an outward direction, and with FIG. 44 depicting the improved fold-in panels continuing to be pulled or pushed in an outward direction, and with FIG. 45 depicting the improved bottom panels in fully closed condition, and with FIG. 46 depicting the improved fold-in panels beginning to be pulled or pushed in an upward direction, and with FIG. 47 depicting the improved fold-in panels folding on top of the closed improved bottom panels, and with FIG. 48 depicting the improved fold-in panels continue being pushed until the second end edge of the improved fold-in panels lose contact with the closed improved bottom panels, and with FIG. 49 depicting the improved bottom interlocking continuous closure panel now in closed and interlocked condition and remaining in closed and interlocked condition to form an erected carton in accordance with the second aspect (2) of the present invention;

FIG. 50 is a top view of yet another carton blank depicting the new top variable height continuous closure panel in accordance a third aspect (3) of the present invention;

FIG. 51 is an enlarged fragmentary view of area GG depicted in FIG. 50;

FIG. 52 is an enlarged fragmentary view of area HH depicted in FIG. 50;

FIG. 53 depicts the top view of folded and glued carton flat formed from the carton blank depicted in FIG. 50;

FIG. 54 is a perspective view from a side and above of the new top variable height continuous closure panel in fully open and upright condition, the erected carton depicted in FIG. 54 is formed from carton blank depicted in FIG. 50;

FIGS. 55 and 57 depict the progressive closing of the erected carton depicted in FIG. 54, with FIG. 55 depicting the new side fold-in panels of the new top variable height continuous closure panel being pushed or pulled in an inward and downward direction, thereby causing said new top variable height continuous closure panel to be in partially closed condition, and with FIG. 57 depicting the new top variable height continuous closure panel now in fully closed condition, thereby closing said erected carton to its lower height in accordance with the third aspect (3) of the present invention;

FIGS. 56 and 58 depict the progressive closing of the erected carton depicted in FIG. 54, with FIG. 56 depicting the new end fold-in panels of the new top variable height continuous closure panel being pushed or pulled in an inward and downward direction, thereby causing said new top variable height continuous closure panel to be in partially closed condition, and with FIG. 58 depicting the new top variable height continuous closure panel now in fully closed condition, thereby closing said erected carton to its higher height in accordance with the third aspect (3) of the present invention.

### DETAILED DESCRIPTIONS OF EMBODIMENTS

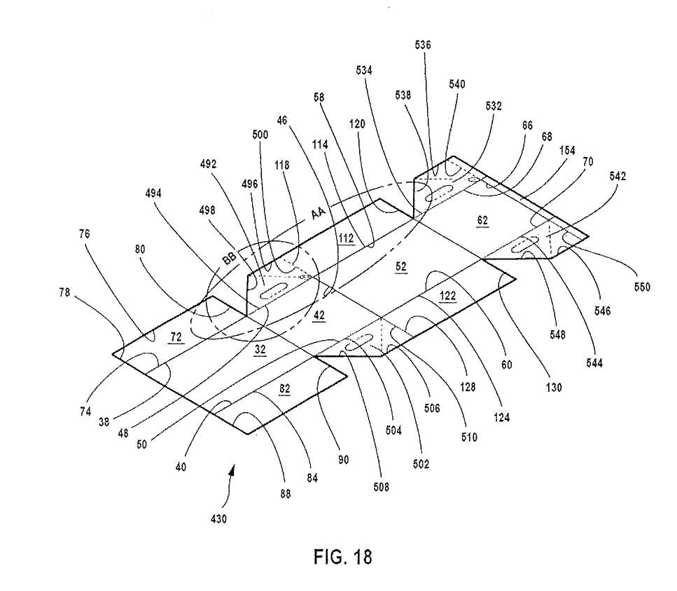

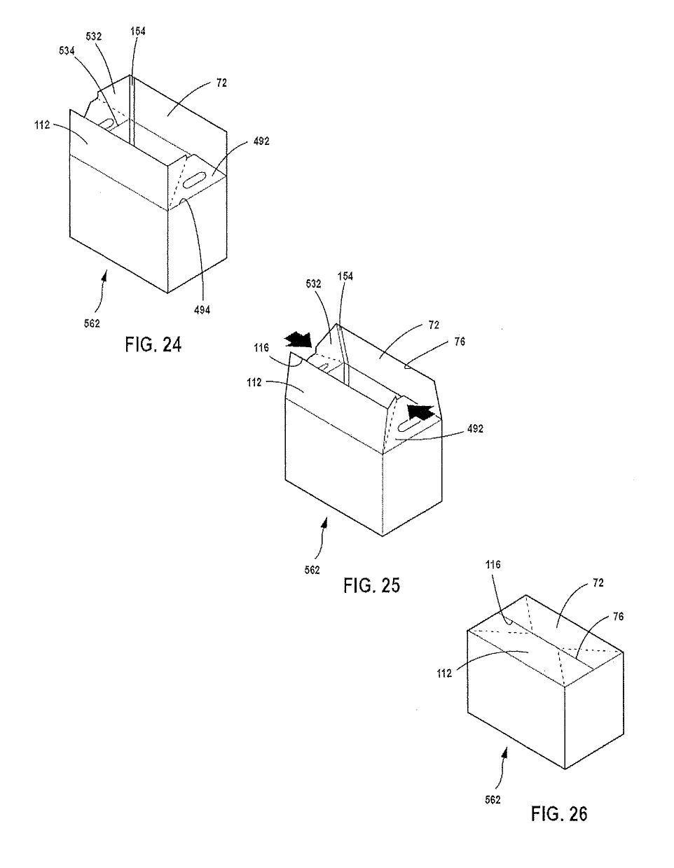

According to the example embodiment of the present invention described herein and illustrated by accompanying drawings FIGS. 18-36, the aforementioned carton stacking and quick and easy carton erection and closure advantages of the present invention described herein are attained by an improved carton blank 430 or 431 or 432 having new flexible continuous closure panels to produce an improved carton 562 or 563 or 564 therefrom according to the present invention; wherein instead of the top and bottom continuous closure panels of the known invention, the present invention described herein carton blank 430 has new top flexible Style A continuous closure panel and new bottom Style A flexible continuous closure panel, with said new top Style A flexible continuous closure panel having two top panels that are substantially the same as prior art and having two improved fold-in panels according to the present invention, with said top Style A flexible continuous closure panel having top panel 72 and 112 and fold-in panel 492 and 532, and with said improved fold-in panels and said top panels folding on transverse 180° fold lines that are uniquely designed to facilitate fold-in panels 492 and 532 to fold in an inward direction, as well as to fold in an opposite outward direction, and with said bottom Style A flexible continuous closure panels having two bottom panels that are substantially the same as prior art and having two improved fold-in panels according to the present invention, with said bottom Style A flexible continuous closure panel having bottom panel 82 and 112 and fold-in panel 502 and 542, and with said improved fold-in panels and said bottom panels folding on transverse 180° fold lines that are uniquely designed to facilitate fold-in panels 502 and 542 to fold in an inward direction, as well as to fold in an opposite outward direction.

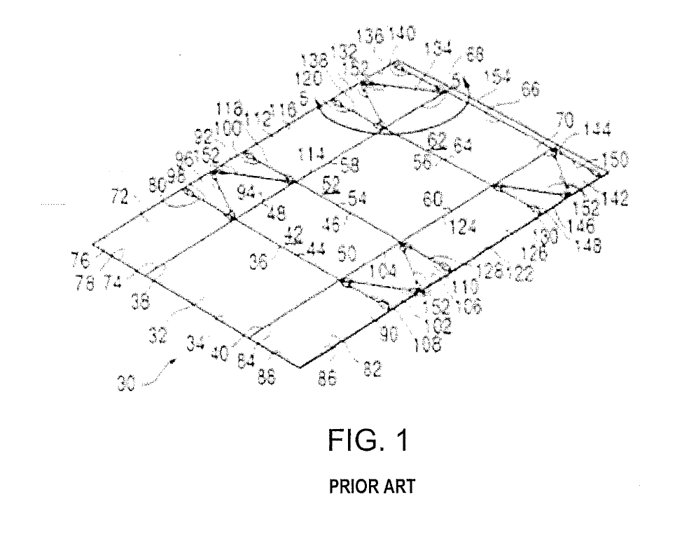

As illustrated by accompany drawing FIG. 1 and described herein in the ‘Background’ section regarding known carton blank 30 of the known invention, side panels 32 and 52, end panels 42 and 62, top panels 72 and 112, bottom panels 82 and 122, all said panels having edges and 90° fold lines therebetween that are substantially the same as prior art, and having sealing strip 154 that is substantially the same as prior art; details thereof set forth in the ‘Background’ section are not repeated here but are incorporated by reference from the aforementioned U.S. patents.

However, according to the present invention described herein and illustrated by accompanying drawings FIGS. 18, 19A, and 20A, construction of said improved carton blank 430 differs from the known carton blank 30, wherein said improved carton blank 430 has improved first fold-in panel 492, improved second fold-in panel 502, improved third fold-in panel 532, and improved fourth fold-in panel 542; wherein said fold-in panel 492 has a first end edge 494, a second end edge 496, a first side edge 498, and a second side edge 500, and with said fold-in panel 492 having a first end edge 494 that is substantially parallel with second end edge 496, and with a second end edge 496 that is substantially half as long as first end edge 494, and with first end edge 494 an extension of edge 74, and with second side edge 500 an extension of edge 46, and with first side edge 498 starting at the point where first end edge 494 and edge 74 meet, and with first side edge 498 extending at an angle to second end edge 496, thereby creating said fold-in panel 492 in a one-sided trapezoid shape; wherein as illustrated by accompanying drawing FIG. 18, said carton blank 430 includes said fold-in panel 502 having a first end edge 504, a second end edge 506, a first side edge 508, and a second side edge 510, with said fold-in panel 502 having a first end edge 504 that is substantially parallel with second end edge 506, and with second end edge 506 that is substantially half as long as first end edge 504, and with first end edge 504 an extension of edge 84, and with second side edge 510 an extension of edge 46, and with first side edge 508 starting at the point where first end edge 504 and edge 84 meet, and with first side edge 508 extending at an angle to second end edge 506, thereby creating said fold-in panel 502 in a one-sided trapezoid shape; and with said carton blank 430 also including said fold-in panel 532 having a first end edge 534, a second end edge 536, a first side edge 538, and a second side edge 540, with said fold-in panel 532 having a first end edge 534 that is substantially parallel with second end edge 536, and with second end edge 536 that is substantially half as long as first end edge 534, and with first end edge 534 an extension of edge 114, and with second side edge 540 an extension of edge 66, and with first side edge 538 starting at the point where first end edge 534 and edge 114 meet, and with first side edge 538 extending at an angle to second end edge 536, thereby creating said fold-in panel 532 in a one-sided trapezoid shape; and with said carton blank 430 also including said fold-in panel 542 having a first end edge 544, a second end edge 546, a first side edge 548, and a second side edge 550, said fold-in panel 542 having a first end edge 544 that is substantially parallel with second end edge 546, and with second end edge 546 that is substantially half as long as first end edge 544, and with first end edge 544 an extension of edge 124, and with second side edge 550 an extension of edge 66, and with first side edge 548 starting at the point where first end edge 544 and edge 124 meet, and with first side edge 548 extending at an angle to second end edge 546, thereby creating said fold-in panel 542 in a one-sided trapezoid shape.

According to the present invention described herein and illustrated by accompanying drawings FIGS. 18, 19A, and 20A, said fold-in panel 492 is an extension of first end panel 42 with first end edge 494 joined to top edge 48 to define a fifth 90° fold line, and with said fold-in panel 492 an extension of second top panel 112 with second side edge 500 joined to first end edge 118 to define a fourth 180° fold line, and with said fold-in panel 502 an extension of first end panel 42 with first end edge 504 joined to bottom edge 50 to define a sixth 90° fold line, and with said fold-in panel 502 an extension of second bottom panel 122 with second side edge 510 joined to first end edge 128 to define a fifth 180° fold line, and with said fold-in panel 532 an extension of second end panel 62 with first end edge 534 joined to top edge 68 to define a ninth 90° fold line, and with sealing strip 154 an extension of said fold-in panel 532, with side edge 540 joined to sealing strip 154 to define an eighth 180° fold line, and with said fold-in panel 542 an extension of second end panel 62 with first end edge 544 joined to bottom edge 70 to define a tenth 90° fold line, and with sealing strip 154 and extension of said fold-in panel 542, and with side edge 550 joined to sealing strip 154 to define a ninth 180° fold line.

According to the present invention described herein and illustrated by accompanying drawings FIGS. 18, 19A, and 20A, said fold-in panel 492 includes transverse 180° fold line 552, said fold line 552 having a first end at the intersection of second end edge 496 and first side edge 498, and said fold line 552 having a second end at the intersection of first end edge 494 and second side edge 500; wherein as illustrated by accompanying drawing FIG. 18, said fold-in panel 502 includes said fold line 552 having a first end at the intersection of second end edge 506 and first side edge 508, and said fold line 552 having a second end at the intersection of first end edge 504 and second side edge 510, and said fold-in panel 532 also including said fold line 552 having a first end at the intersection of second end edge 536 and first side edge 538, and said fold line 552 having a second end at the intersection of first end edge 534 and second side edge 540, and said fold-in panel 542 also including said fold line 552 having a first end at the intersection of second end edge 546 and first side edge 548, and said fold line 552 having a second end at the intersection of first end edge 544 and second side edge 550.

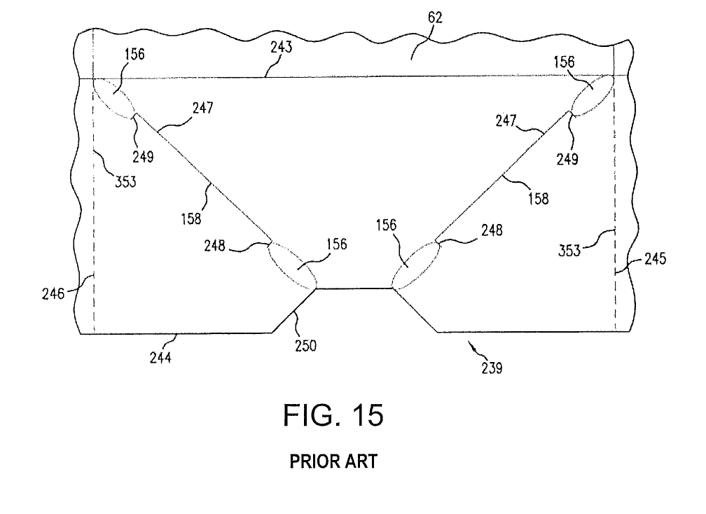

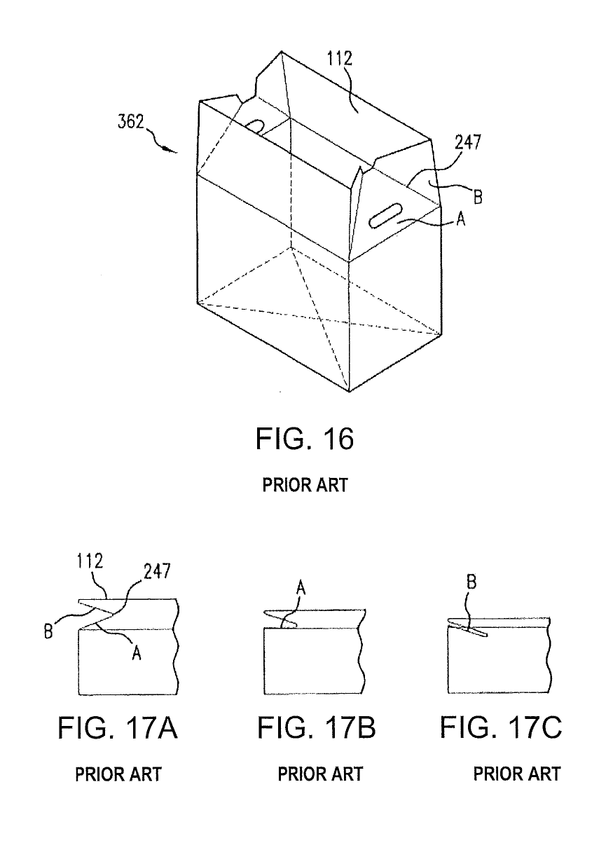

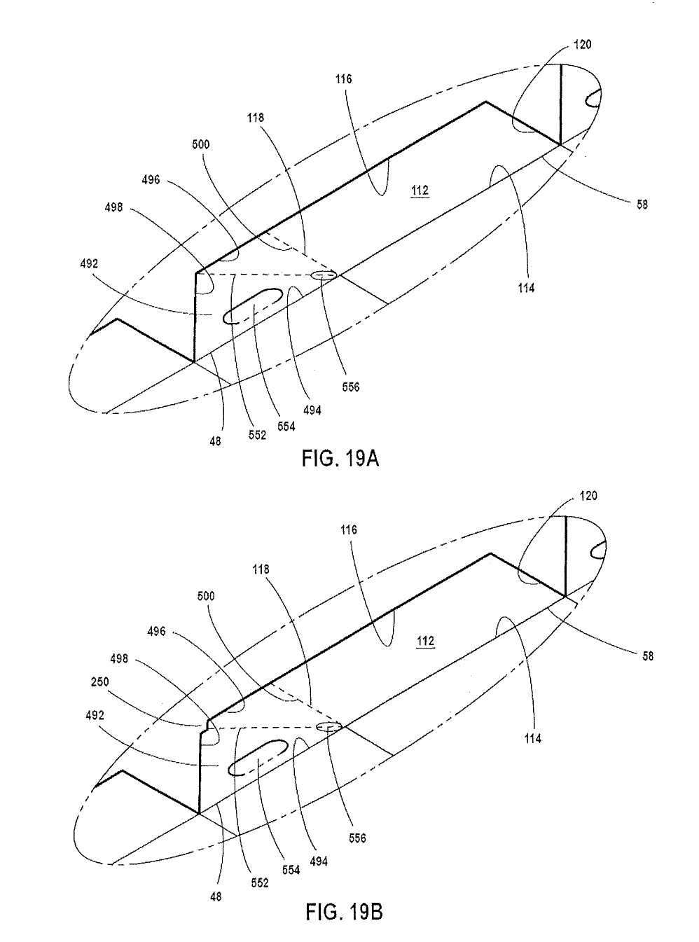

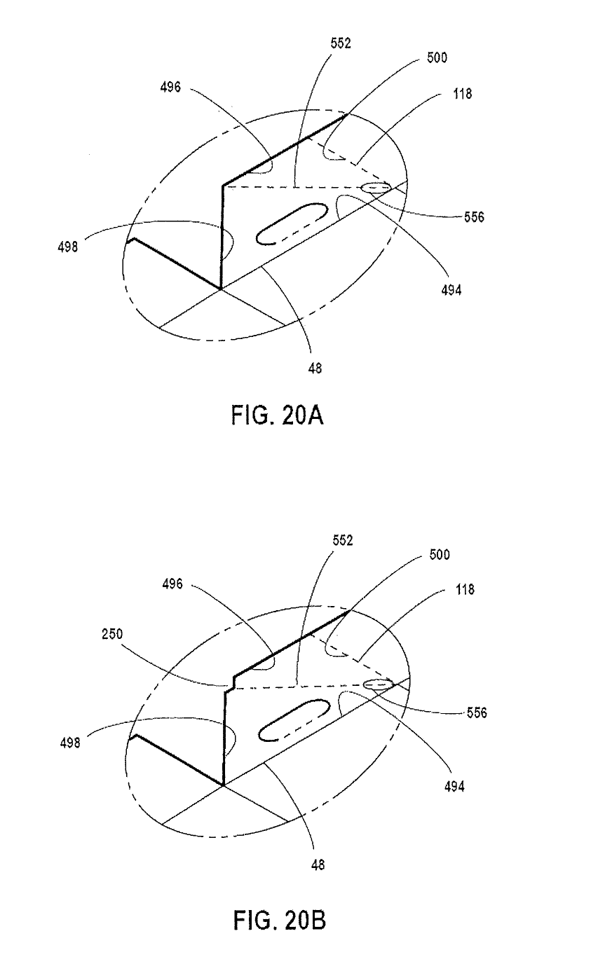

According to the present invention described herein and illustrated by accompanying drawings FIGS. 18, 19A, and 20A, each transverse 180° fold line 552 includes incremental cuts extending along the partial or entire length of said fold line 552, with said fold line 552 including a compressed area 556 extending partially along or entirely along the length of said fold line 552; wherein compressed area 556 and said incremental cuts extend along fold line 552, and wherein said incremental cuts extend through carton blank 430, fold-in panels 492, 502, 532, and 542 allow said fold-in panels to flex outwardly and fold in each of opposite directions along said fold line; wherein as illustrated in FIGS. 19A and 20A, compressed area 556 extends from second ends of said fold lines 552 for a distance on the order of about two inches. Each compressed area 556 preferably is oval in shape with a maximum width on the order of from about ⅜ inch to about ¾ inch. As can be seen in FIG. 15 in connection with the explanation of the known carton blank 30, each compressed area 556 extends into the material of the carton blank a substantial distance, while leaving the adjacent panel portions joined. Preferably, a protrusion 160 extends from the undersurface of said carton blank 430 substantially along the center line of each compressed area 556 to define a fold line.

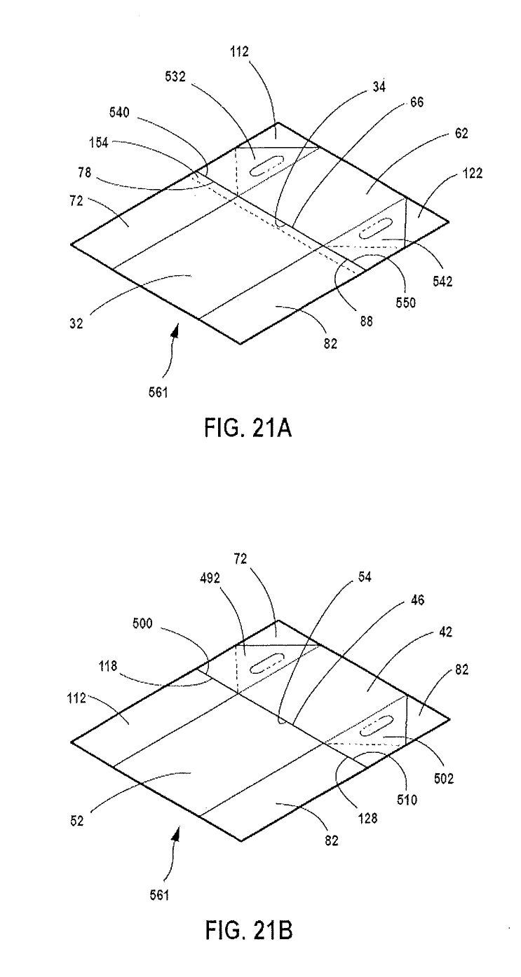

According to the present invention described herein and illustrated by accompanying drawing FIG. 21A, said improved carton flat 561 is formed from said carton blank 430 when said carton blank 430 is folded and glued at sealing strip 154; wherein said new top Style A flexible continuous closure panel has said fold-in panel 532 that is an extension of said first top panel 72 with said fold-in panel 532 second side edge 540 that is joined to said first top panel 72 first end edge 78 at said eighth 180° fold line, and with said new bottom Style A flexible continuous closure panel having said fold-in panel 542 that is an extension of first bottom panel 82 with said fold-in panel 542 second side edge 550 that is joined to said first bottom panel 82 first end edge 88 at said ninth 180° fold line.

According to the present invention described herein and illustrated by accompanying drawing FIG. 21B, said carton flat 561 is formed from carton blank 430 when said carton blank 430 is folded and glued at sealing strip 154; wherein said new top Style A flexible continuous closure panel has said fold-in panel 492 that is an extension of second top panel 112 with said fold-in panel 492 second side edge 500 joined to said second top panel 112 first end edge 118 at said fourth 180° fold line; wherein said new bottom Style A flexible continuous closure panel has said fold-in panel 502 that is an extension of second bottom panel 122 with said fold-in panel 502 second side edge 510 joined to said second bottom panel 122 first end edge 128 at said fifth 180° fold line.

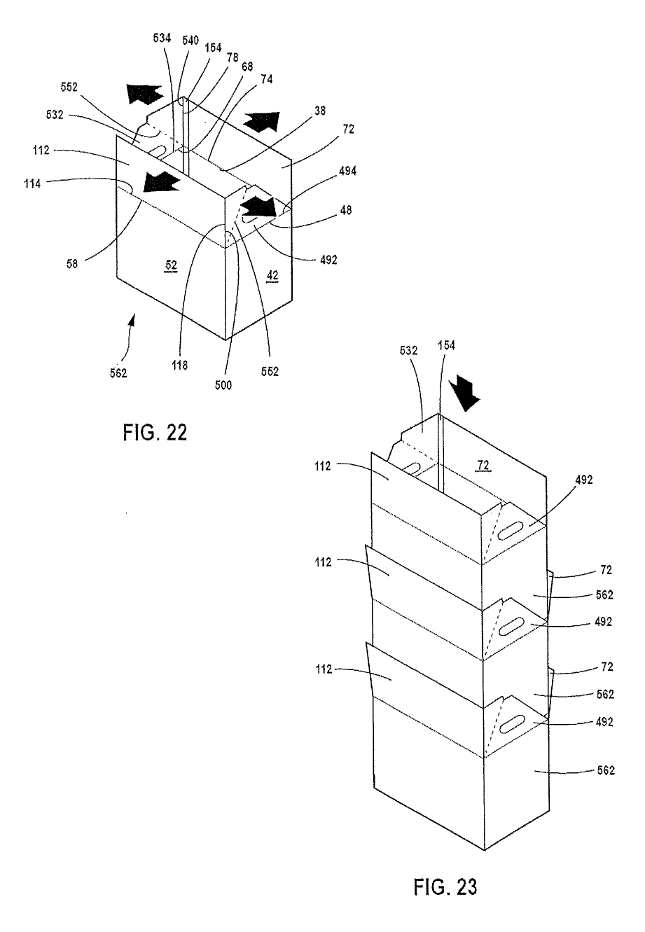

According to the present invention described herein and illustrated by accompanying drawings FIGS. 22 and 23, when said carton 562 is in erected condition defined herein as having new bottom continuous closure panels in closed condition and new top Style A flexible continuous closure panel in open condition, the closed bottom of said erected carton 562 can be inserted into the open top of another said carton 562, both said cartons formed from said same carton blank 430, to achieve the advantage of stacking previously erected and open cartons without limit as to the height of the stack.

According to the present invention described herein and illustrated by accompanying drawings FIGS. 22, 24-26, said carton 562 when in erected condition can be closed when one or both said fold-in panels 492 and 532 of said new top Style A flexible continuous closure panel begin to be pulled or pushed in a downward and inward direction, said fold-in panels 492 and 532 begin folding in a downward and inward direction on said transverse 180° fold lines 552 and on said fifth and ninth 90° fold lines respectively and on said fourth and eighth 180° fold lines respectively, and said first and second top panels 72 and 112 begin folding in a downward and inward direction on said third and seventh 90° fold lines respectively, and as one or both said first and second top panels 72 and 112 begin to be pushed in a downward and inward direction and continue folding on said third and seventh 90° fold lines, said fold-in panels 492 and 532 continue folding on all said fold lines in a downward and inward direction until said fold-in panels 492 and 532 fold over on top of themselves and the second side edges 76 and 116 of said top panels meet to cause said carton 562 to be in fully closed condition.

According to the present invention described herein and illustrated by accompanying drawings FIGS. 19B and 20B, changes can be made to the construction of the trapezoid shapes in said fold-in panel 492 to include a fold control notch 250 substantially midway between the first and second side edges of said fold-in panel 492 and still achieve the same stacking results within the scope of the present invention described herein.

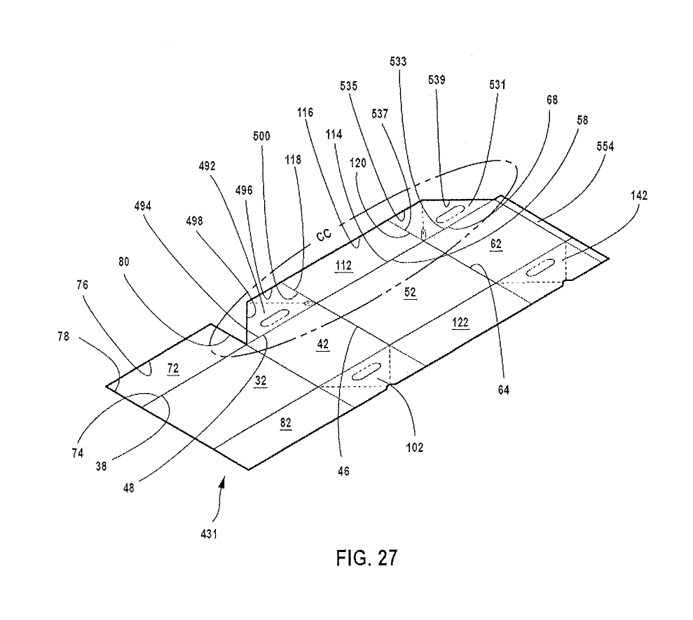

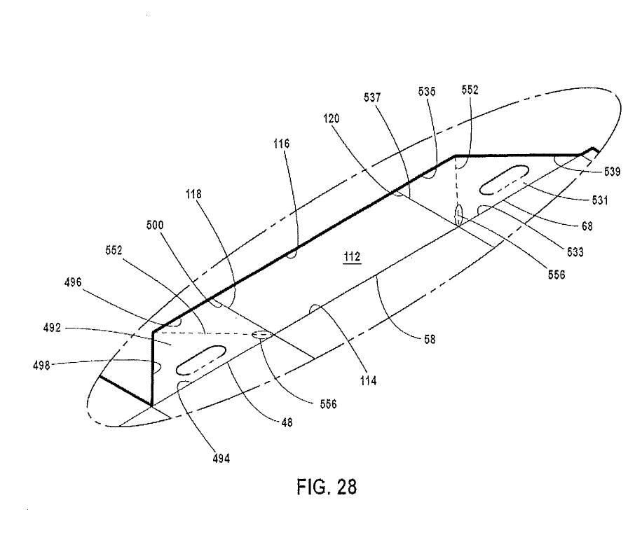

According to a further feature of the present invention described herein and illustrated by accompanying drawings FIGS. 27 and 28, wherein said carton blank 431, instead of having said new top Style A flexible continuous closure panel has a different new top Style B flexible continuous closure panel, with said new top Style B flexible continuous closure panel having a standalone top panel 72, one said top panel 112 that is substantially the same as prior art, and said new top Style B flexible continuous closure panel having said two improved fold-in panels 492 and 531, with said carton blank 431 having one bottom continuous closure that is substantially the same as prior art; wherein said carton blank 431 has said fold-in panel 492 having a first end edge 494, a second end edge 496, a first side edge 498, and a second side edge 500, with said fold-in panel 492 having first end edge 494 that is substantially parallel with second end edge 496, and second end edge 496 that is substantially half as long as first end edge 494, and with first end edge 494 an extension of edge 74, and with second side edge 500 an extension of edge 46, and with first side edge 498 starting at the point where first end edge 494 and edge 74 meet, and with first side edge 498 extending at an angle to second end edge 496, thereby creating said fold-in panel 492 in a one-sided trapezoid shape; wherein said carton blank 431 has said fold-in panel 531 having a first end edge 533, a second end edge 535, a first side edge 537, and a second side edge 539, with said fold-in panel 531 having a first end edge 533 that is substantially parallel with the second end edge 535, and having a second end edge 535 that is substantially half as long as first end edge 533, and with first end edge 533 an extension of edge 114, and with first side edge 537 an extension of edge 64, and with second side edge 539 starting at the end point of first end edge 433 closest to glue tab 554, and with second side edge 539 extending at an angle to second end edge 535, thereby creating said fold-in panel 531 in a one-sided trapezoid shape.

According to the present invention described herein and illustrated by accompanying drawing FIG. 27, said fold-in panel 492 is an extension of said first end panel 42 with first end edge 494 joined to top edge 48 to define a fifth 90° fold line, and with said fold-in panel 492 an extension of said second top panel 112 with second side edge 500 joined to end edge 118 to define a fourth 180° fold line, and with said fold-in panel 531 an extension of second end panel 62 with first end edge 533 joined to top edge 68 to define a ninth 90° fold line, and with said fold-in panel 531 an extension of said second top panel 112 with first side edge 537 joined to second end edge 120 to define a sixth 180° fold line.

According to the present the invention described herein and illustrated by accompanying drawing FIG. 28, said fold-in panel 492 includes transverse 180° fold line 552, said fold line 552 having a first end at the intersection of second end edge 496 and first side edge 498 and also having a second end at the intersection of first end edge 494 and second side edge 500, said fold-in panel 531 also includes transverse 180° fold line 552, with said fold line having a first end at the intersection of second end edge 535 and second side edge 539 and also having a second end at the intersection of first end edge 533 and first side edge 537.

According to the present invention described herein and illustrated by accompanying drawings FIGS. 27 and 28, transverse 180° fold lines 552 include incremental cuts extending along the partial or entire length of said fold lines 552, with said fold lines 552 including a compressed area 556 extending partially along or entirely along the length of said fold lines 552.

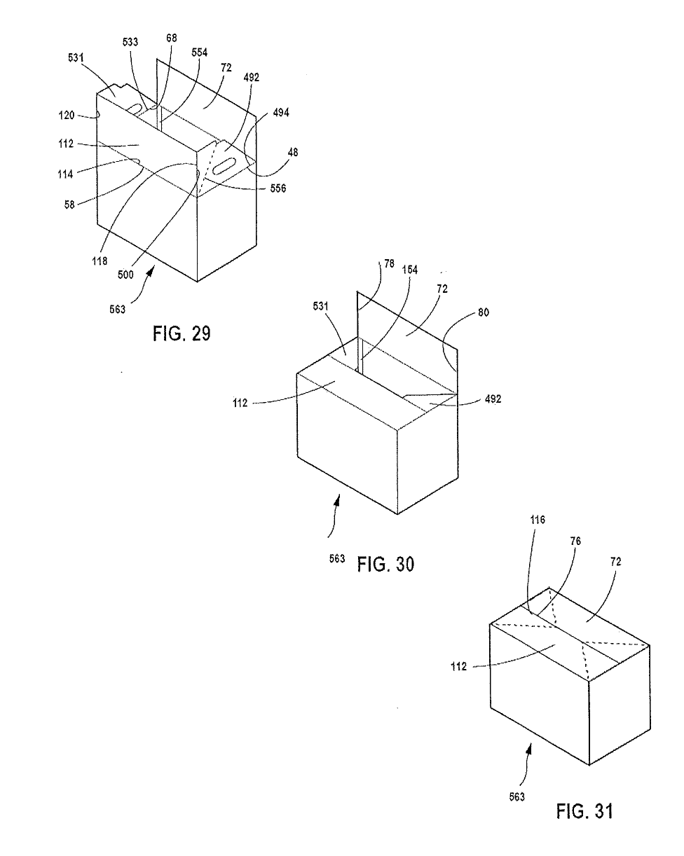

According to the present invention described herein and illustrated by accompanying drawings FIGS. 29-31, said carton 563 when in erected condition can be closed when one or both said fold-in panels 492 and 531 of the new top Style B flexible continuous closure panel begin to be pulled or pushed in a downward and inward direction, said fold-in panels 492 and 531 begin folding in a downward and inward direction on said transverse 180° fold lines 552 and on said fifth and ninth 90° fold lines respectively and on said fourth and sixth 180° fold lines respectively, and said second top panel 112 begins folding in a downward and inward direction on said seventh 90° fold line, and as said second top panel 112 begins to be pushed in a downward and inward direction and continues folding on said seventh 90° fold line, said fold-in panels 492 and 531 continue folding on all said fold lines in a downward and inward direction until said fold-in panels 492 and 531 fold over on top of themselves, and said fourth and sixth 180° fold lines meet said fifth and ninth 90° fold lines respectively, and when downward and inward pressure is applied to the top of top panel 72, said top panel 72 folds on said third 90° fold line until edges 78 and 80 meet said fifth and ninth 90° fold lines respectively to cause carton 563 to be in closed condition.

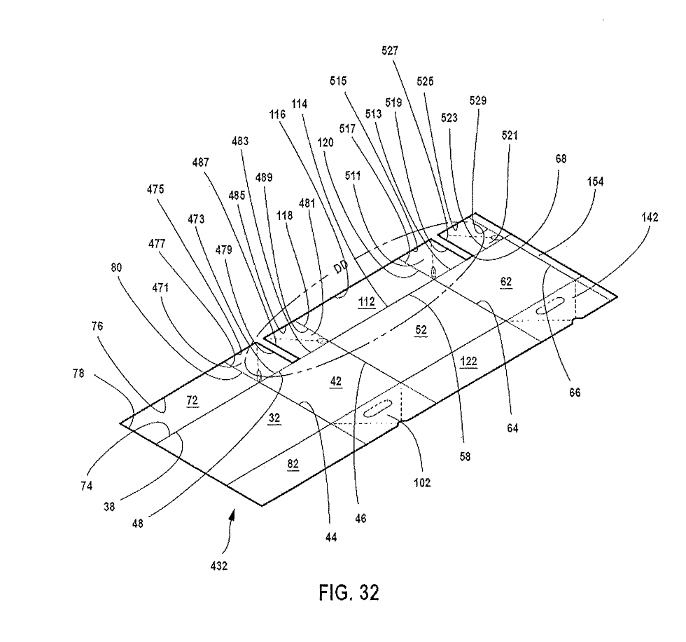

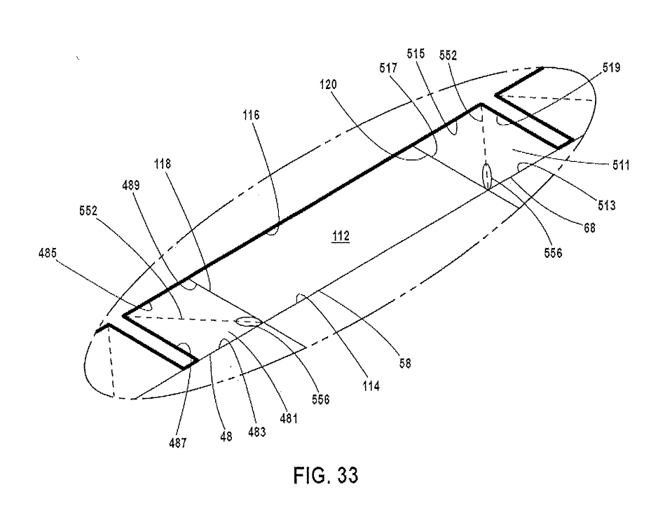

According to a further feature of the present invention described herein and illustrated by accompanying drawings FIGS. 32 and 33, said carton blank 432 instead of having the top continuous closure panel of the known invention, the present invention has yet another new top Style C flexible continuous closure panel, with said new top Style C flexible continuous closure panel having one top panel 72 that is substantially the same as prior art, and also having a new first partial fold-in panel 471 and a new fourth partial fold-in panel, 521, and with said new top Style C flexible continuous closure panel having one said top panel 112 that is substantially the same as prior art, and also having a new second partial fold-in panel 481 and a new third partial fold-in panel 511, and with said carton blank 432 having one bottom continuous closure panel that is substantially the same as prior art; wherein said carton blank 432 has said partial fold-in panel 471 having a first end edge 473, a second end edge 475, a first side edge 477, and a second side edge 479, and said partial fold-in panel 471 having said first end edge 473 that is substantially parallel with said second end edge 475, and with said first end edge 473 an extension of edge 74, and with said second end edge 475 an extension of edge 76, and with said first side edge 477 that is substantially parallel with said second side edge 479, and with said first side edge 477 an extension of edge 44; wherein said carton blank 432 has said partial fold-in panel 481 having a first end edge 483, a second end edge 485, a first side edge 487, and a second side edge 489, and with said partial fold-in panel 481 having said first end edge 483 that is substantially parallel with said second end edge 485, and with said first end edge 483 an extension of edge 114, and said second end edge 485 an extension of edge 116, and with said first side edge 487 that is substantially parallel with second side edge 489, and with said second side edge 489 an extension of edge 46; wherein said carton blank 432 has said partial fold-in panel 511 having a first end edge 513, a second end edge 515, a first side edge 517, and a second side edge 519, and said partial fold-in panel 511 having said first end edge 513 that is substantially parallel with second end edge 515, and with said first end edge 513 an extension of edge 114, and said second end edge 515 an extension of edge 116, and with said first side edge 517 that is substantially parallel with second said side edge 519, and with said first side edge 517 an extension of edge 64; wherein said carton blank 432 has a new fourth partial fold-in panel 521 having a first end edge 523, a second end edge 525, a first side edge 527, and a second side edge 529, and said partial fold-in panel 521 having said first end edge 523 that is substantially parallel with said second end edge 525, and with said first and second end edges 523 and 525 that are substantially parallel with edge 68, and with said first side edge 527 that is substantially parallel with said second side edge 529, and with said second side edge 529 an extension of edge 66.

According to the present invention described herein and illustrated by accompanying drawing FIG. 32, said first partial fold-in panel 471 is an extension of first end panel 42 with said first end edge 473 joined to top edge 48 to define the first part of the fifth 90° fold line, and with said partial fold-in panel 471 an extension of said first top panel 72 with said first side edge 477 joined to end edge 80 to define a second 180° fold line, and with said partial fold-in panel 481 an extension of said first end panel 42 with said first end edge 483 joined to said top edge 48 to define the second part of the fifth 90° fold line, and with said partial fold-in panel 481 an extension of said second top panel 112 with said second side edge 489 joined to end edge 118 to define a fourth 180° fold line, and with said partial fold-in panel 511 an extension of said second end panel 62 with said first end edge 513 joined to top edge 68 to define the first part of the ninth 90° fold line, and with said partial fold-in panel 511 an extension of said second top panel 112 with said first side edge 517 joined to second end edge 120 to define a sixth 180° fold line, and with said partial fold-in panel 521 an extension of said second end panel 62 with said first end edge 523 joined to said top edge 68 to define the second part of the ninth 90° fold line, and when said carton blank 432 is folded and glued, said partial fold-in panel 471 is an extension of said first top panel 72 with said second side edge 529 joined to said first end edge 78 to define an eighth 180° fold line.

According to the present invention described herein and illustrated by accompanying drawings FIGS. 32 and 33, wherein said partial fold-in panel 471 includes said transverse 180° fold lines 552, said fold lines 552 having a first end at the intersection of said second end edge 475 and said second side edge 479, and also having a second end at the intersection of said first end edge 473 and said first side edge 477; wherein said partial fold-in panel 481 includes said fold lines 552 having a first end at the intersection of said second end edge 485 and said first side edge 487, and also having said second end edge 483 and said second side edge 489, with said edges 479 and 487 defining a shape cut out between the first and second partial fold-in panels 471 and 481 of the top Style C flexible continuous closure panel; wherein said partial fold-in panel 511 includes said fold lines 552 having a first end at the intersection of said second end edge 515 and said second side edge 519, and also having a second end at the intersection of said first end edge 513 and said first side edge 517; wherein said partial fold-in panel 521 includes said fold lines 552 having a first end at the intersection of said second end edge 525 and said first side edge 527, and also having a second end at the intersection of said first end edge 523 and said second side edge 529, with said edges 519 and 527 defining a shape cut out between the third and fourth partial fold-in panels 511 and 521 of the top Style C flexible continuous fold-in panel.

According to the present invention described herein and illustrated by accompanying drawings FIGS. 32 and 33, each transverse 180° fold line 552 includes incremental cuts extending along the partial or entire length of said fold lines 552, with said fold lines 552 including a compressed area 556 extending partially along or entirely along the length of said fold lines 552.

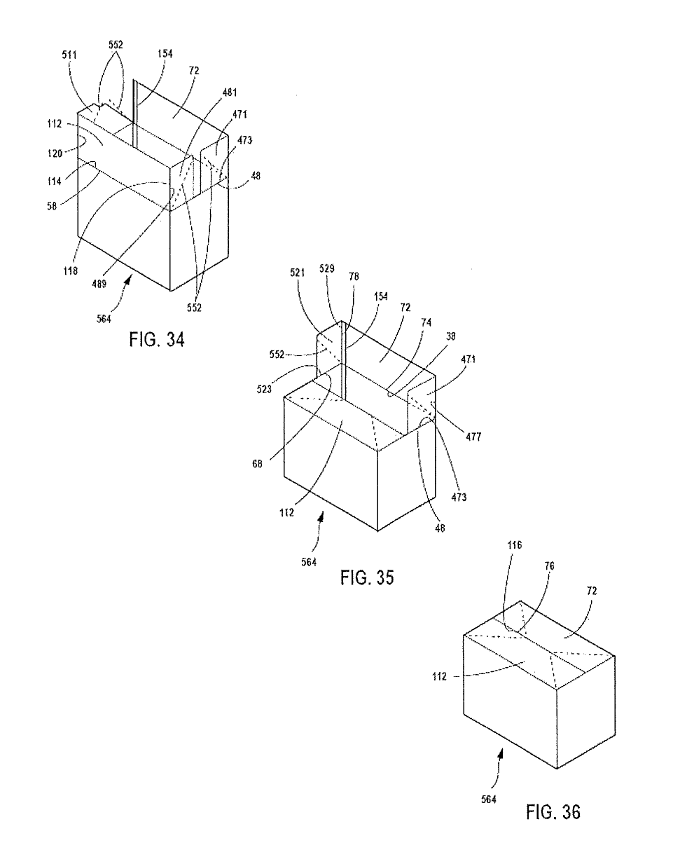

According to the present invention described herein and illustrated by accompanying drawings FIGS. 34 and 35, improved carton 564 can be closed on one side when one or both said partial fold-in panels 481 and 511 of said top Style C flexible continuous closure panel begin to be pulled or pushed in a downward and inward direction, and said partial fold-in panels 481 and 511 begin folding in a downward and inward direction on said fifth and ninth 90° fold lines and on said fourth and sixth 180° fold lines respectively and on all said transverse 180° fold lines 552, and said second top panel 112 begins folding in a downward and inward direction on said seventh 90° fold line, and as said second top panel 112 begins to be pushed in a downward and inward direction and continues folding on said seventh 90° fold line, partial fold-in panels 481 and 511 continue folding on all aforementioned said fold lines in a downward and inward direction until said partial fold-in panels 481 and 511 fold over on top of themselves and said fourth and sixth 180° fold lines meet said fifth and ninth 90° fold lines respectively, thereby causing said first top panel 112 with both partial fold-in panel 481 and 511 to be in closed condition; wherein as illustrated by accompanying drawing FIGS. 35 and 36, said carton 564 can be closed on the other side when one or both said partial fold-in panels 471 and 521 of said top Style C flexible continuous closure panel begin to be pulled or pushed in a downward and inward direction, and said fold-in panels 471 and 521 begin folding in a downward and inward direction on said fifth and ninth 90° fold lines and on said second and eighth 180° fold lines respectively and on all said transverse 180° fold lines 552, and first top panel 72 begins folding in a downward and inward direction on said third 90° fold line, and as said first top panel 72 begins to be pushed in a downward and inward direction and continues folding on said third 90° fold line, fold-in panels 471 and 521 continue folding on all aforementioned said fold lines in a downward and inward direction until said fold-in panels 471 and 521 fold over on top of themselves and said second and eighth 180° fold lines meet said fifth and ninth 90° fold lines, thereby causing said second top panel 72 with both partial fold-in panels 471 and 521 and carton 564 to be in closed condition.

The present invention according to the first aspect (1) has been described herein with reference to a preferred embodiment; however, rearrangements, alternations and substitutions can be made and still the result would be within the scope of the present invention. For example, instead of said carton blank 430 illustrated in FIG. 18 for forming an improved carton having said new bottom Style A flexible continuous closure panels and having said new top Style A flexible continuous closure panels as described herein regarding the present invention, a different improved carton blank can have new bottom Style A or B or C flexible continuous closure panels with a top continuous panel as described in the aforementioned U.S. patents, or a different improved carton blank can have said new top Style A or B flexible continuous closure panels and can have said new bottom Style A or B flexible continuous closure panels, said new Style A or B flexible continuous closure panels having a trapezoidal shape fold-in panel, said fold-in panel having a fold control notch of any shape cut out of the top of the fold-in panel, an example of said notch is shown in FIGS. 19B and 20B, or a different improved carton blank can have said new top Style A or B or C flexible continuous closure panels and can have said new bottom Style A or B or C flexible continuous closure panels, said new flexible continuous closure panels having features according to example embodiments of said improved fold-in panels of the present invention described herein.

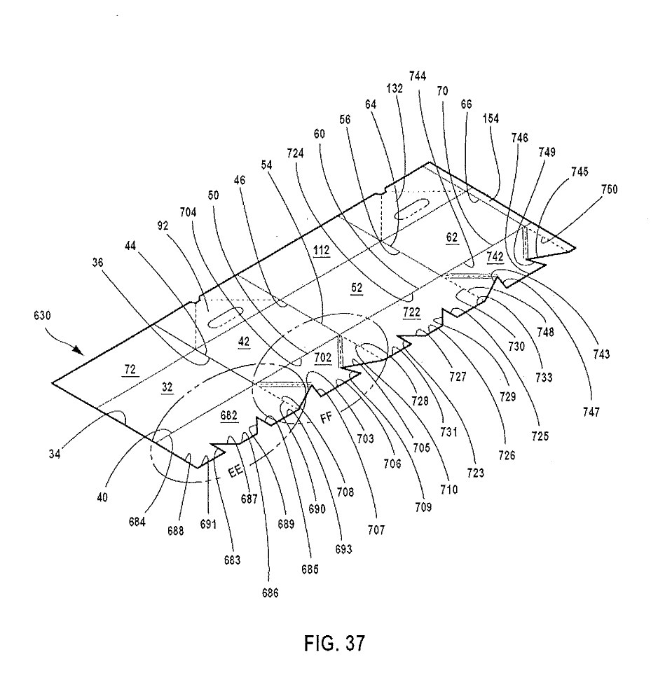

According to the example embodiment of a second aspect (2) of the present invention described herein and illustrated by accompanying drawings FIGS. 37, 38A and 39A, the aforementioned advantages of an erected carton to remain in closed condition without requiring taping, gluing, stapling or other assistance when said carton is moved, of the present invention described herein are attained by an improved carton blank 630 to produce an improved carton 762 therefrom according to the present invention, wherein the top continuous closure panel is substantially the same as prior art, and instead of the bottom continuous closure panel of the known invention, the present invention described herein has an improved bottom interlocking continuous closure panel having an improved first bottom panel 682 and an improved second bottom panel 722, and having an improved second fold-in panel 702 and an improved fourth fold-in panel 742, said fold-in panels 702 and 742 interlocking with said bottom panels 682 and 722 respectively wherein said improved bottom interlocking continuous closure panel folds according to the present invention described herein, and with said fold-in panels 702 and 742 extending from said bottom panels 682 and 722 respectively, and with said fold-in panels 702 and 742 and said bottom panels 682 and 722 folding on transverse 180° fold lines allowing fold-in panels 702 and 742 to fold in an inward direction, as well as to fold in an opposite outward direction.

As illustrated by accompany drawing FIG. 1 and described herein in the ‘Background’ section regarding carton blank 30 of the known invention, side panels 32 and 52, end panels 42 and 62, top panels 72 and 112, first fold-in panel 92, and third fold-in panel 132, all said panels having edges, 90° fold lines and 180° fold lines therebetween are substantially the same as prior art, and having sealing strip 154 that is substantially the same as prior art; details thereof set forth in the ‘Background’ section are not repeated here but are incorporated by reference from the aforementioned U.S. patents.

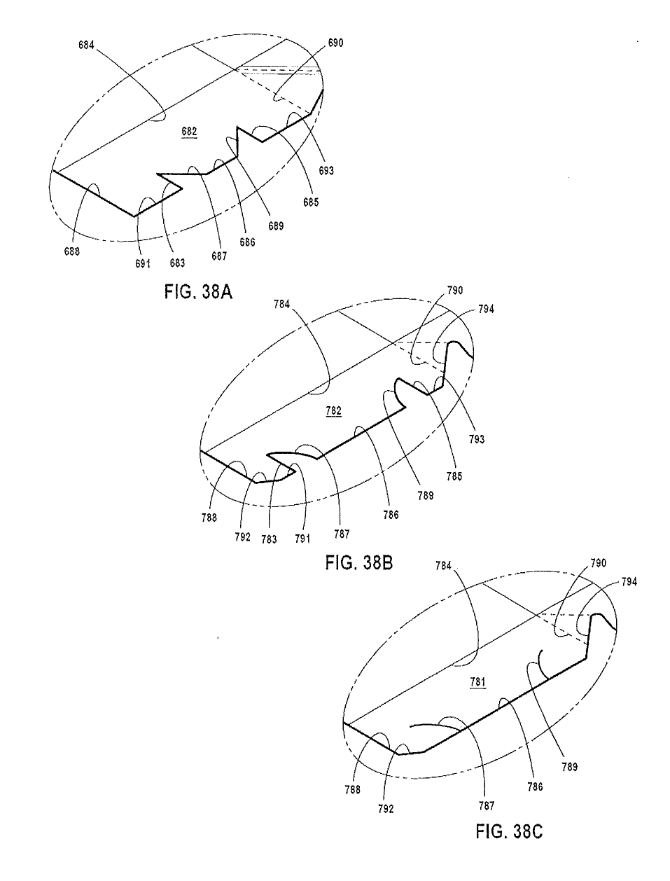

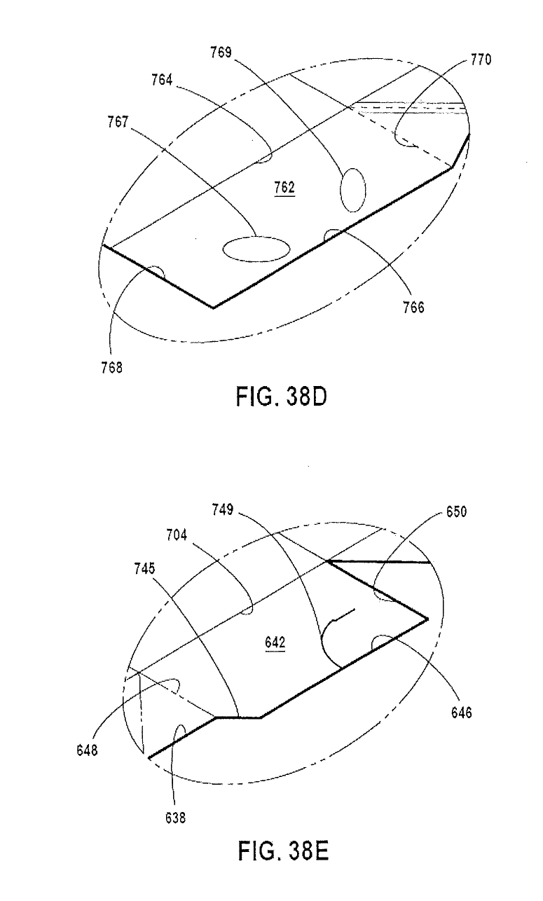

However, according to the present invention described herein and illustrated by accompanying drawings FIGS. 37 and 38A, construction of said improved carton blank 630 differs from the known carton blank 30, wherein said carton blank 630 includes an improved bottom interlocking continuous closure panel consisting of improved first and second bottom panels 682 and 722 and of improved second and fourth fold-in panels 702 and 742; wherein said carton blank 630 includes said first bottom panel 682 having a first end edge 688, a second end edge 690, a first side edge 684, and instead of having a continuous second side edge, said second side edge has a first end section 691, a middle section 686, a second end section 693, with said three sections separated by two V-shape notches, and with said bottom panel 682 having said first end edge 688 that is an extension of edge 34, with said second end edge 690 an extension of edge 36, and with said bottom panel 682 having said first side edge 684 that is substantially parallel with bottom edge 40, and said bottom panel 682 having said first end section 691, said middle section 686, and said second end section 693 of said second side edge, with said three sections substantially parallel with said bottom edge 40, and with said bottom panel 682 having a first notch edge 683 starting at said first end section 691 of said second side edge at a distance from said first end edge 688 and extending a distance inward to a point on bottom panel 682, and said bottom panel 682 having a first locking edge 687 starting at the point of said middle section 686 of said second side edge closest to said first end edge 688 and extending a distance inward to meet at the same point where said first notch edge 683 ends on said first bottom panel 682, with said bottom panel 682 having said first notch edge 683 and said first locking edge 687 defining the first V-shape notch, and with said bottom panel 682 having a second notch edge 685 starting at said second end section 693 of said second side edge at a distance from said second end edge 690 and extending a distance inward to a point on said bottom panel 682, and with said bottom panel 682 having a second locking edge 689 starting at the end of said middle section 686 of said second side edge closest to said second end edge 690 and extending a distance inward to meet at the same point where said second notch edge 685 ends on said bottom panel 682, and with said bottom panel 682 having said second notch edge 685 and said second locking edge 689 defining the second V-shape notch; wherein said first and second locking edges 687 and 689 and said middle section 686 of said second side edge create an isosceles trapezoid shape in said first bottom panel 682.

According to the present invention described herein and illustrated by accompanying drawing FIG. 37, said carton blank 630 includes said second bottom panel 722 having a first end edge 728, a second end edge 730, a first side edge 724, and instead of having a continuous second side edge, said second side edge has a first end section 731, a middle section 726, a second end section 733, with said three sections separated by two V-shape notches, and with said bottom panel 722 having said first end edge 728 that is an extension of edge 54, with said second end edge 730 an extension of edge 56, and with said bottom panel 722 having said first side edge 724 that is substantially parallel with bottom edge 60, and said bottom panel 722 having said first end section 731, said middle section 726, and said second end section 733 of said second side edge, with said three sections substantially parallel with said bottom edge 60, and with said bottom panel 722 having a first notch edge 723 starting at said first end section 731 of said second side edge at a distance from said first end edge 728 and extending a distance inward to a point on said bottom panel 722, and with said bottom panel 722 having first locking edge 727 starting at the point of said middle section 726 of said second side edge closest to said first end edge 728 and extending a distance inward to meet at the same point where said first notch edge 723 ends on said second bottom panel 722, with said bottom panel 722 having said first notch edge 723 and said first locking edge 727 defining the first V-shape notch, and with said bottom panel 722 having a second notch edge 725 starting at said second end section 733 of said second side edge at a distance from said second end edge 730 and extending a distance inward to a point on said bottom panel 722, and with said bottom panel 722 having a second locking edge 729 starting at the end of said middle section 726 of said second side edge closest to said second end edge 730 and extending a distance inward to meet at the same point where said second notch edge 725 ends on said bottom panel 722, and with said bottom panel 722 having said second notch edge 725 and said second locking edge 729 defining the second V-shape notch; wherein said first and second locking edges 727 and 729 and said middle section 726 of said second side edge create an isosceles trapezoid shape in said second bottom panel 722.

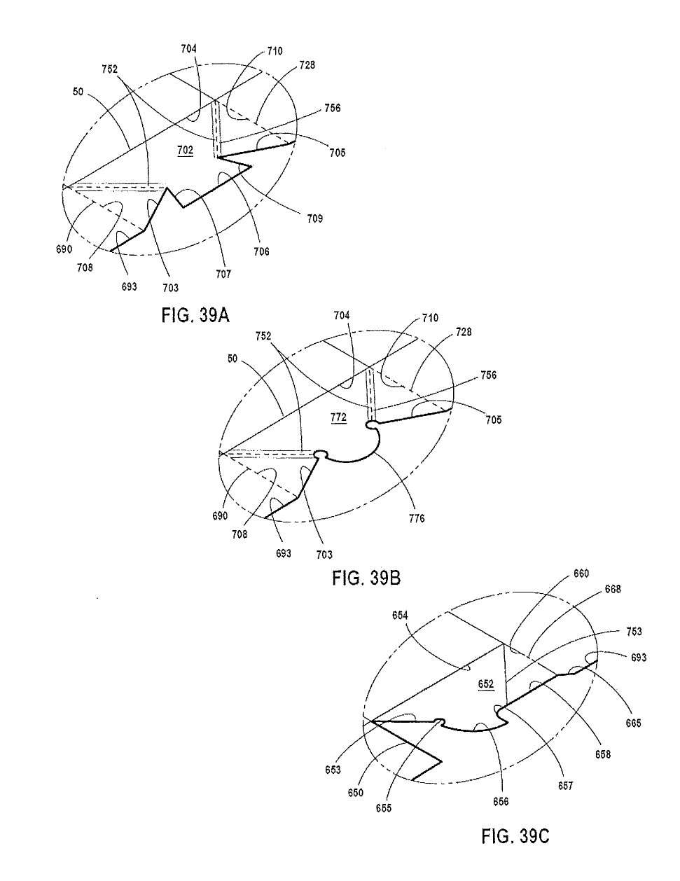

According to the present invention described herein and illustrated by accompanying drawings FIGS. 37 and 39A, said carton blank 630 includes a second fold-in panel 702 having a first side edge 708, a second side edge 710, a first end edge 704, and a second end edge 706, and having two V-shape notches with one notch at each end of said second end edge 706, and with said fold-in panel 702 having said first side edge 708 that is an extension of edge 44, and having said second side edge 710 an extension of edge 46, with said side edges 708 and 710 substantially parallel with said second end edge 690, and with said fold-in panel 702 having said first end edge 704 and said second end edge 706 that are substantially parallel with bottom edge 50, and with said fold-in panel 702 having a first notch edge 703 starting at a point on said first side edge 708 closest to said second end edge 706 and extending at an angle a distance inward to a point on said fold-in panel 702, and with said fold-in panel 702 having a first locking edge 707 starting at the point on said second end edge 706 closest to said first side edge 708 and extending a distance inward to meet at the same point where said first notch edge 703 ends on said fold-in panel 702, and with said fold-in panel 702 having a first notch edge 703 and said first locking edge 707 defining the first V-shape notch, and with said fold-in panel 702 having a second notch edge 705 starting at the point of said second side edge 710 closest to said second end edge 706 and extending at an angle a distance inward to a point on said fold-in panel 702, and with said fold-in panel 702 having a second locking edge 709 starting at the point on said second end edge 706 closest to said second side edge 710 and extending at an angle a distance inward to meet at the same point where said second notch edge 705 ends on said fold-in panel 702, and with said fold-in panel 702 having said second notch edge 705 and said second locking edge 709 defining the second V-shape notch; wherein said first and second locking edges 707 and 709 and said second end edge 706 create an isosceles trapezoid shape in said second fold-in panel 702.

According to the present invention described herein and illustrated by accompanying drawing FIG. 37, said carton blank 630 includes a fourth fold-in panel 742 having a first side edge 748, a second side edge 750, a first end edge 744, and a second end edge 746, and having two V-shape notches with one notch at each end of said second end edge 748, and with said fold-in panel 742 having said first side edge 748 that is an extension of edge 64, and having said second side edge 750 an extension of edge 66, with said side edges substantially parallel with said second end edge 730, and with said fold-in panel 742 having said first end edge 744 and said second end edge 746 that are substantially parallel with bottom edge 70, and with said fold-in panel 742 having a first notch edge 743 starting at a point on said first side edge 748 closest to said second end edge 746 and extending at an angle a distance inward to a point on said fold-in panel 742, and with said fold-in panel 742 having a first locking edge 747 starting at the point on second end edge 746 closest to said first side edge 748 and extending a distance inward to meet at the same point where said first notch edge 743 ends on said fold-in panel 742, and with said fold-in panel 742 having a first notch edge 743 and said first locking edge 747 defining the first V-shape notch, and with said fold-in panel 742 having a second notch edge 745 starting at the point of said second side edge 750 closest to said second end edge 746 and extending at an angle a distance inward to a point on said fold-in panel 742, and with said fold-in panel 742 having a second locking edge 749 starting at the point on said second end edge 746 closest to said second side edge 750 and extending at an angle a distance inward to meet at the same point where said second notch edge 745 ends on said fold-in panel 742, and with said fold-in panel 742 having said second notch edge 745 and said second locking edge 749 defining the second V-shape notch; wherein said first and second locking edges 747 and 749 and said second end edge 746 create an isosceles trapezoid shape in said fourth fold-in panel 742.

According to the present invention described herein and illustrated by accompanying drawings FIGS. 38B, 38C, 38D and 38E, changes can be made to the construction of the trapezoid shapes in said first bottom panel 682 and said second bottom panel 722 and still achieve the same interlocking results within the scope of the present invention described herein.

According to the present invention describe herein and illustrated by accompanying drawings FIGS. 39B and 39C, changes can be made to the construction of the trapezoid shapes in said second fold-in panel 702 and said fourth fold-in panel 742 and still achieve the same interlocking results within the scope of the present invention described herein.

According to the present invention described herein and illustrated by accompanying drawing FIGS. 37, 38A, 38B, 38C, 38D and 38E, said improved first bottom panel 682 extends from first side panel 32 with said first side edge 684 joined to bottom edge 40 to define the fourth 90° fold line, and with said improved second fold-in panel 702 extending from first end panel 42 with said first end edge 704 joined to bottom edge 50 to define the sixth 90° fold line, and with said improved second bottom panel 722 extending from second side panel 52 with said first side edge 724 joined to bottom edge 60 to define the eighth 90° fold line, and with said improved forth fold-in panel 742 extending from second end panel 62 with said first end edge 744 joined to bottom edge 70 to define the tenth 90° fold line, and with said bottom panel 682 extending from said fold-in panel 702 with said second end edge 690 joined to said first side edge 708 to define the third 180° fold line, and with said fold-in panel 702 extending from said bottom panel 722 with said second side edge 710 joined to said first end edge 728 to define the fifth 180° fold line, and with said bottom panel 722 extending from said fold-in panel 742 with said second end edge 730 joined to said first side edge 748 to define the seventh 180° fold line, and with said fold-in panel 742 extending from sealing strip 154 with said second side edge 750 joined to sealing strip 154 to define the ninth 180° fold line.

According to the present invention described herein and illustrated by accompanying drawings FIGS. 37, 39A, 39B and 39C, said second fold-in panel 702 and said fourth fold-in panel 742 each having one or more transverse 180° fold lines 752, with said fold-in panel 702 having transverse 180° fold line 752 extending from a point at the intersection of said first notch edge 703 and said first locking edge 707 to a second end at a point at the intersection of said first end edge 704 and said first side edge 708, and with said fold-in panel 702 said fold line 752 extending from a point at the intersection of said second notch edge 705 and said second locking edge 709 to a second end at a point at the intersection of said first end edge 704 and said second side edge 710, and with said fold-in panel 742 having said fold line 752 extending from a point at the intersection of said first notch edge 743 and said first locking edge 747 to a second end at a point at the intersection of said first end edge 744 and said first side edge 748, and with said fold-in panel 742 having said fold line 752 extending from a point at the intersection of said second notch edge 745 and said second locking edge 749 to a second end at a point at the intersection of said first end edge 744 and said second side edge 750, with said fold lines 752 are incrementally cut partially or fully the length of said fold lines 752, and with said fold lines 752 including a compressed area 756 extending partially or fully along one or both sides of all aforesaid fold lines 752, allowing the fold-in panels 702 and 742 to fold in an inward direction, as well as to fold in an opposite outward direction.

According to the present invention described herein and illustrated by accompanying drawing FIG. 15, each compressed area 756 extends into the material of improved carton blank 630 a substantial distance while leaving the adjacent panel portions joined. Preferably, a protrusion 160 extends from the undersurface of said carton blank 630 substantially along the center line of each compressed area 756 to define all aforesaid fold lines 752.

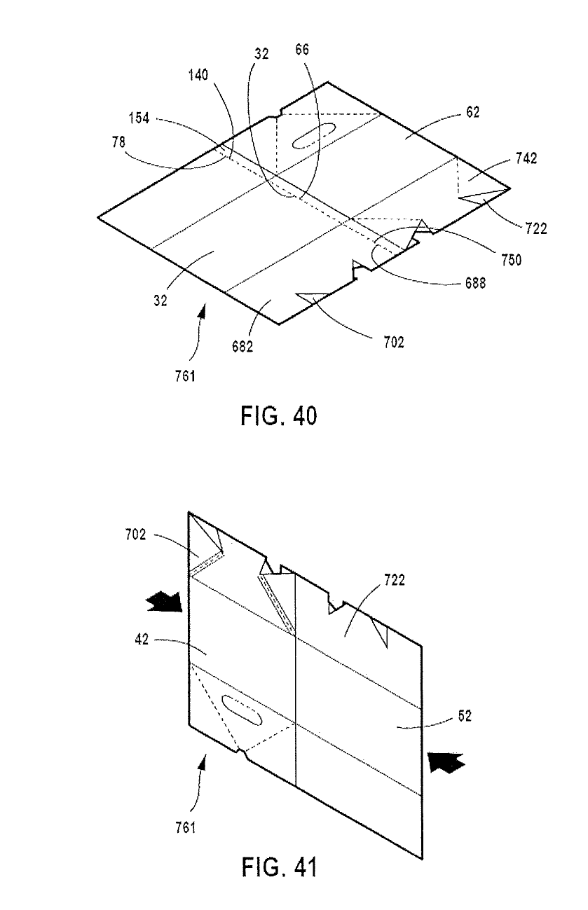

According to the present invention described herein and illustrated by accompanying drawing FIG. 40, improved carton flat 761 is formed from said improved carton blank 630 when carton blank 630 is folded and glued at sealing strip 154, with said bottom interlocking continuous closure panel having said fourth fold-in panel 742 extending from said first bottom panel 682 with said second side edge 750 joined to said first end edge 688 at the said ninth 180° fold line.

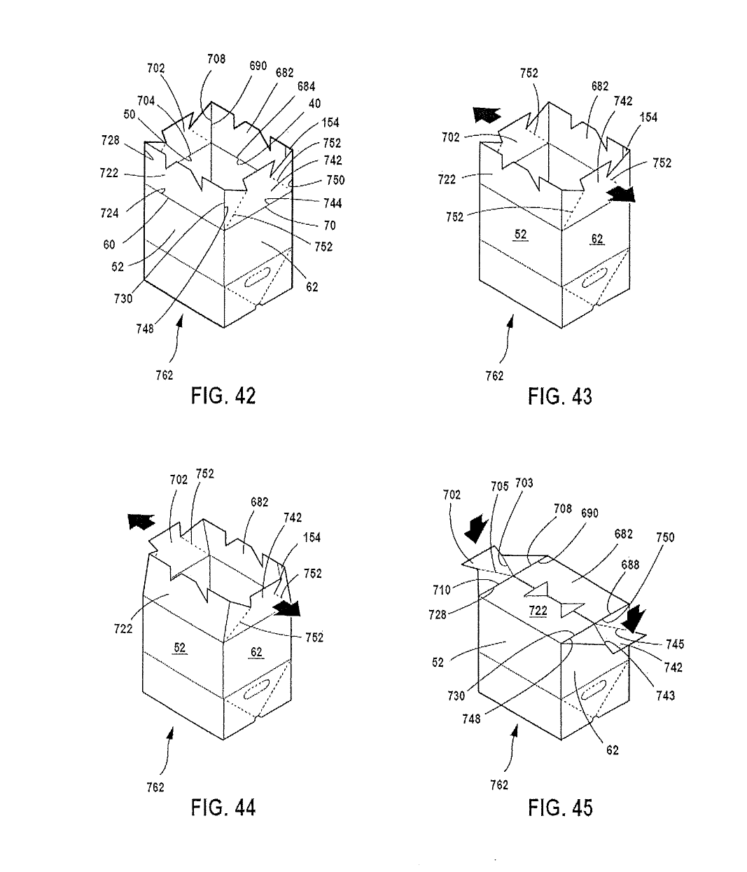

According to said improved carton blank 630 of the present invention described herein, said carton blank 630 is folded and glued to form improved carton flat 761; as described herein and illustrated by accompanying drawings FIGS. 41 and 42, when said carton flat 761 is placed on the top edge of said top continuous closure panel, and when inward pressure simultaneously is applied to the end fold lines of said carton flat 761, said carton flat 761 is squared off to erect an improved carton 762 having bottom and top continuous closure panels in open condition.

According to the present invention described herein and illustrated by accompanying drawing FIG. 43, said bottom interlocking continuous closure panel of said erected carton 762 can be closed and interlocked with said second fold-in panel 702 and said fourth fold-in panel 742 when said fold-in panels 702 and 742 begin being pushed or pulled in an outward direction thereby causing said fold-in panel 702 to begin folding in an outward and downward direction on said sixth 90° fold line and on said third and fifth 180° fold lines and on said transverse 180° fold lines 752, and also thereby causing said fold-in panel 742 to begin folding in an outward and downward direction on said tenth 90° fold line and on said seventh and ninth 180° fold lines and on said transverse 180° fold lines 752, and also thereby causing said bottom panels 682 and 722 to begin folding in a downward and inward direction on said fourth and eighth 90° fold lines respectively.

According to the present invention described herein and illustrated by accompanying drawing FIG. 44, as said fold-in panels 702 and 742 continue being pushed or pulled in an outward direction, said fold-in panel 702 continues folding in an outward and downward direction on said sixth 90° fold line and on said third and fifth 180° fold lines and on said transverse 180° fold lines 752, and said fold-in panel 742 continues folding in an outward and downward direction on said tenth 90° fold line and on said seventh and ninth 180° fold lines and on said transverse 180° fold lines 752, thereby causing said bottom panels 682 and 722 to continue folding in a downward and inward direction on said fourth and eighth 90° fold lines respectively.

According to the present invention described herein and illustrated by accompanying drawing FIG. 45, as said fold-in panels 702 and 742 now are pushed or pulled outward in a downward direction, said fold-in panel 702 continues folding in an outward and downward direction on said sixth 90° fold line and on said third and fifth 180° fold lines and on said transverse 180° fold lines 752, and said fold-in panel 742 continues folding in an outward and downward direction on said tenth 90° fold line and on said seventh and ninth 180° fold lines and on said transverse 180° fold lines 752, until said fold-in panels 702 and 742 completely fold over themselves on said transverse 180° fold line 752 until said second side edge of said bottom panel 682 meets said second side edge of said bottom panel 722, thereby causing said bottom panels 682 and 722 to be in closed condition.

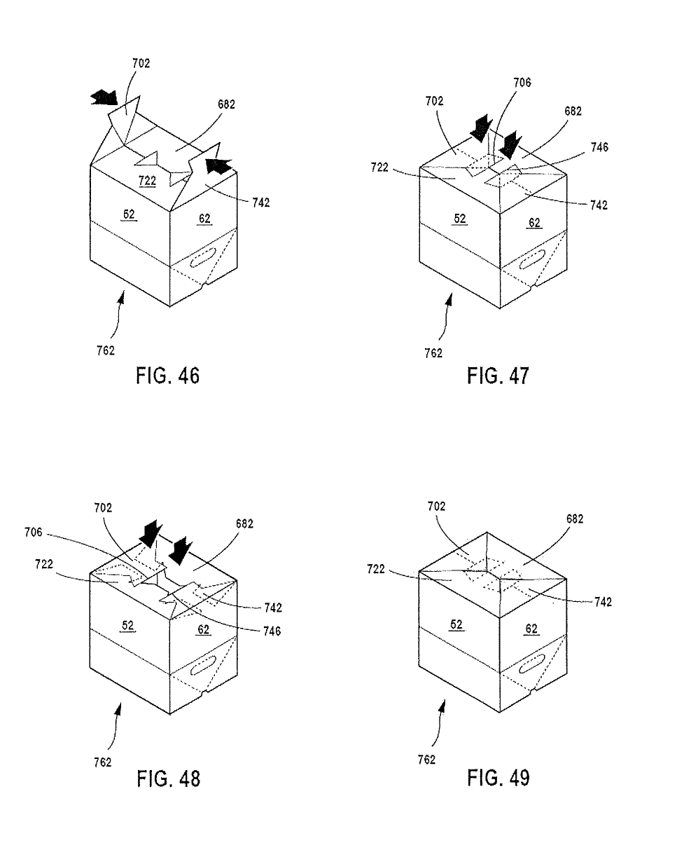

According to the present invention described herein and illustrated by accompanying drawing FIG. 46, as said fold-in panels 702 and 742 are now pushed or pulled in an upward direction, said fold-in panels 702 and 742 begin folding on the sixth and tenth 90° fold lines respectively in an upward direction toward each other, wherein said bottom panels 682 and 722 remain in closed condition.

According to the present invention described herein and illustrated by accompanying drawing FIG. 47, as said fold-in panels 702 and 742 now are pushed inward in a downward direction until said fold-in panels 702 and 742 meet bottom said panels 682 and 722 respectively.

According to the present invention described herein and illustrated by accompanying drawing FIG. 48, as said fold-in panels 702 and 742 continue being pushed inward in a downward direction, downward pressure is applied to the top of said bottom panels 682 and 722 until said bottom panels 682 and 722 move in a downward direction far enough so said second end edge 706 of said fold-in panel 702 and said second end edge 746 of said fold-in panel 742 lose contact with said bottom panels 682 and 722, and until said second end edge 706 of said fold-in panel 702 and said second end edge 746 of said fold-in panel 742 move beneath bottom panels 682 and 722, thereby causing said fold-in panels 702 and 742 to begin to interlock with said bottom panels 682 and 722.

According to the present invention described herein and illustrated by accompanying drawing FIG. 49, when downward pressure ceases on said fold-in panels 702 and 742, said fold-in panels 702 and 742 and said bottom panels 682 and 722 spring back in an upward direction, and said first and second locking edges of said fold-in panels 702 and 742 remaining under said first and second locking edges of said bottom panels 682 and 722, thereby causing said fold-in panels 702 and 742 and said bottom panels 682 and 722 to fully interlock together at the respective notches of said fold-in panels 702 and 742 and said bottom panels 682 and 722, thereby causing said bottom interlocking continuous closure panel to be in closed condition and to remain in closed condition without need of taping, gluing, stapling or other assistance to remain in closed condition.

The second aspect (2) of the present invention has been described herein with reference to a preferred embodiment; however, rearrangements, alternations and substitutions can be made and still the result would be within the scope of the present invention. For example, instead of said improved carton blank 630 illustrated in FIG. 37 for forming an improved carton having a top continuous closure panel as described in the aforementioned U.S. Patents and having a new bottom interlocking continuous closure panel described herein regarding the present invention, a different improved carton blank can have new top Style A or B or C flexible continuous closure panels as described herein regarding the present invention and as illustrated by accompanying drawing FIGS. 18, 27, and 32, and said improved carton blank can have said new bottom interlocking continuous closure panel as described herein regarding the present invention as illustrated by accompanying drawings FIGS. 38B, 38C, 38D, and 39B; or a different improved carton blank can have said new top Style A or B or C flexible continuous closure panels with said new bottom interlocking continuous closure panel having features according to example embodiments of said improved fold-in panels of the present invention described herein and illustrated by accompanying drawings FIGS. 38E and 39C.

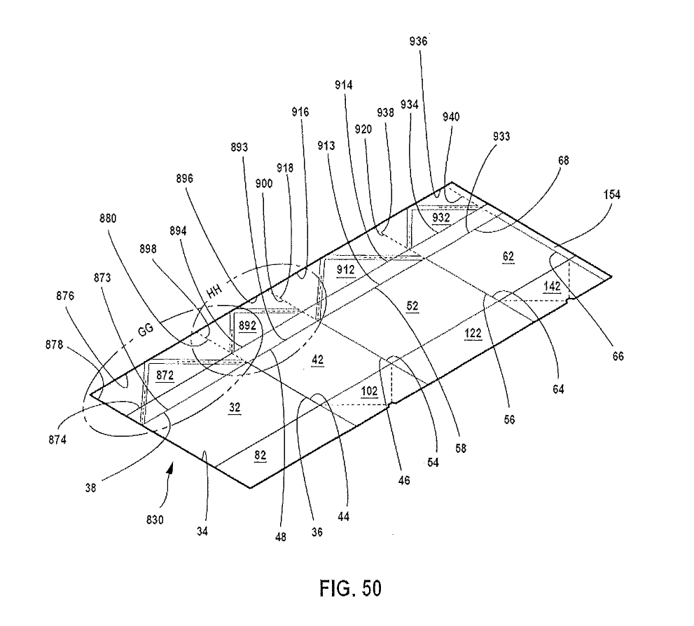

According to a third aspect (3) of the present invention described herein and illustrated by accompanying drawings FIGS. 50-52, the aforementioned advantages of a carton that can be closed to one of two different heights is attained the present invention described herein are attained by an improved carton blank 830 to form an improved carton 862 therefrom according to the present invention, wherein the bottom continuous closure panel is substantially the same as prior art, and instead of the top continuous closure panel of the known invention, the present invention described herein has a new top variable height continuous closure panel having a new first side fold-in panel 872 and a new second side fold-in panel 912, and having a new first end fold-in panel 892 and a new second end fold-in panel 932, said fold-in panels 872, 912, each having a higher 90° fold lines and said fold-in panels 892, and 932 each having a lower 90° fold lines, with said fold-in panels 872 and 912 joined to said fold-in panels 892 and 932, with all said fold-in panels folding on transverse 180° fold lines uniquely designed to facilitate fold-in panels 872 and 912 to fold in an outward direction as well as to fold in an opposite inward direction, whereby said improved carton can be closed to one of two different heights.

As illustrated by accompany drawing FIG. 1 and described herein in the ‘Background’ section regarding carton blank 30 of the known invention having side panels 32 and 52, end panels 42 and 62, bottom panels 82 and 122, second fold-in panel 102 and fourth fold-in panel 142, all said panels having edges, 90° fold lines, and 180° fold lines therebetween substantially the same as prior art, and said known carton blank 30 having sealing strip 154 substantially the same as prior art; details thereof set forth in the ‘Background’ section are not repeated here but are incorporated by reference from the aforementioned U.S. patents.

However, according to the third aspect (3) of the present invention described herein and illustrated by accompanying drawings FIGS. 50 and 51, construction of said improved carton blank 830 differs from the known carton blank 30, wherein said improved carton blank 830 includes said new first side fold-in panel 872 having a first end edge 878, a second end edge 880, a first side edge 873, and a second side edge 876, with said first end edge 878 an extension of edge 34, and with said second end edge 880 an extension of edge 36, and with said first side edge 873 substantially parallel to top edge 38, and with said second side edge 876 substantially parallel to said first side edge 873, and said fold-in panel 872 having a higher 90° fold line 874 that is substantially parallel with said first side edge 873 and said fold-in panel 872 having one or two transverse 180° fold lines 953, with said transverse 180° fold line 953 extending from a point on said second side edge 876, with said point substantially midway between said first end edge 878 and said second end edge 880 to a point at the intersection of said first end edge 878 and said first side edge 873, and with the other said transverse 180° fold line 953 extending from a point on said second side edge 876, with said point substantially midway between said first end edge 878 and said second end edge 880 to a point at the intersection of said second end edge 880 and said first side edge 873; wherein said transverse 180° fold lines 953 are incrementally cut partially or fully the length of said fold lines 953, and said fold lines 953 include compressed areas 957 that extend partially or fully along one or both sides of said fold lines 953.

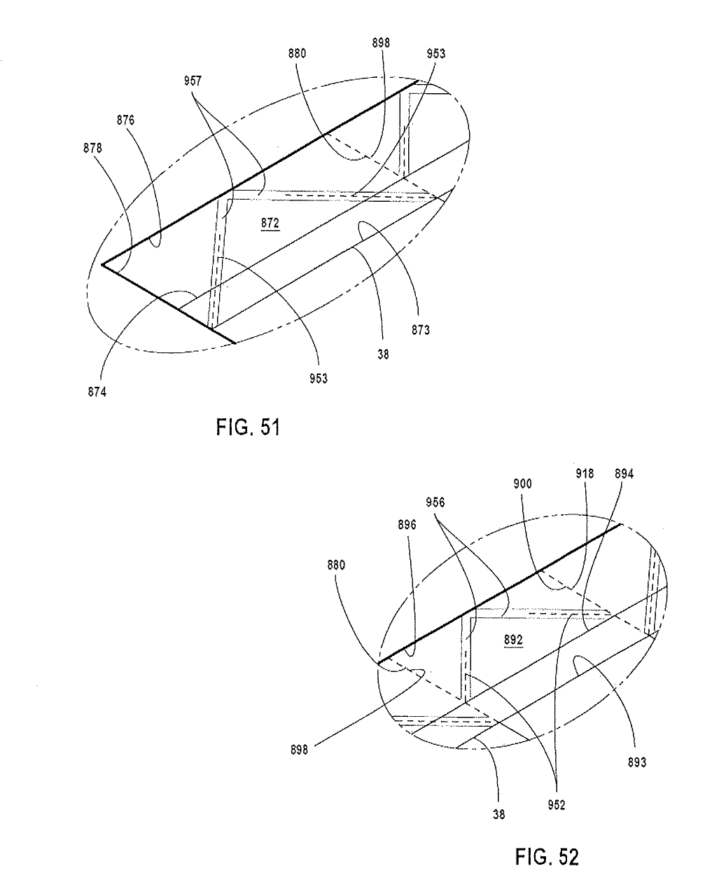

According to the present invention described herein and illustrated by accompanying drawings FIGS. 50 and 52, wherein said improved carton blank 830 includes said new first end fold-in panel 892, having said first side edge 898, a second side edge 900 a first end edge 894, and a second end edge 896, with said first side edge 898 an extension of edge 44, and with said second side edge 900 an extension of edge 46 and with said first end edge 894 is an extension of higher 90° fold line 874, and with said second end edge 896 an extension of said second side edge 876, with said fold-in panel 892 having a lower 90° fold line 893 that is extension of said fold line 873, and with said fold-in panel 892 having one or two transverse 180° fold lines 952, with said transverse 180° fold line 952 extending from a point on said second end edge 896, with said point substantially midway between said first side edge 898 and said second side edge 900 to a point at the intersection of said first side edge 898 and said first end edge 894, and with the other said transverse 180° fold line 952 extending from a point on said second end edge 896, with said point substantially midway between said first side edge 898 and said second side edge 900 to a point at the intersection of said second side edge 900 and said first end edge 894; wherein said transverse 180° fold lines 952 are incrementally cut partially or fully the length of said fold lines 952, and said fold lines 952 include compressed areas 956 that extend partially or fully along one or both sides of said fold lines 952.

According to the present invention described herein and illustrated by accompanying drawing FIG. 50, wherein said improved carton blank 830 includes said new second side fold-in panel 912, having a first end edge 918, a second end edge 920, a first side edge 913, and a second side edge 916, with said first end edge 918 an extension of edge 54, and with said second end 920 an extension of edge 56, and with said first side edge 913 is an extension of lower 90° fold line 893, and with said second side edge 916, is an extension of said end edge 896 and said fold-in panel 912 having a higher 90° fold line 914 that is extension of said fold line 894, and said fold-in panel 912 having one or two transverse 180° fold lines 953, with said transverse 180° fold line 953 extending from a point on said second side edge 916, with said point substantially midway between said first end edge 918 and said second end edge 920 to a point at the intersection of said first end edge 918 and said first side edge 913, and with the other said transverse 180° fold line 953 extending from a point on said second side edge 916, with said point substantially midway between said first end edge 918 and said second end edge 920 to a point at the intersection of said second end edge 918 and said first side edge 913; wherein said 180° fold lines 953 are incrementally cut partially or fully the length of said fold lines 953, and said fold lines 953 include said compressed areas 957 that extend partially or fully along one or both sides of said fold lines 953.

According to the present invention described herein and illustrated by accompanying drawing FIG. 50, wherein said improved carton blank 830 includes said new second end fold-in panel 932 having a first side edge 938, a second side edge 940, a first end edge 934, and a second end edge 936, with said first side edge 938 an extension of edge 64, and with said second side edge 940 an extension of edge 66, and with said first end edge 934 an extension of higher 90° fold line 914, and with said second end edge 936 an extension of said second side edge 916, with said fold-in panel 932 having a lower 90° fold line 933 that is extension of said fold line 913, and with said fold-in panel 932 having one or more transverse 180° fold lines 952, with said transverse 180° fold line 952 extending from a point on said second end edge 936, with said point substantially midway between said first side edge 938 and said second side edge 940 to a point at the intersection of said first side edge 938 and said 90° fold line 934, and with the other said transverse 180° fold line 952 extending from a point on said second end edge 836, with said point substantially midway between said first side edge 938 and said second side edge 940 to a point at the intersection of said second side edge 940 and said 90° fold line 934 wherein said transverse 180° fold lines 952 are incrementally cut partially or fully the length of said fold lines 952, and said fold lines 952 include said compressed areas 956 that extend partially or fully along one or both sides of said fold lines 952.

According to the present invention described herein and illustrated by accompanying drawing FIG. 50, said fold-in panel 872 extending from said side panel 32 with said side edge 873 joined to top edge 38 to define a third 90° fold line, and with said fold-in panel 892 extending from first end panel 42 with said end edge 893 define a fifth 90° fold line, and with said fold-in panel 912 extending from second side panel 52 with said end edge 913 joined to top edge 58 to define a seventh 90° fold line, and with said end fold-in panel 932 extending from second end panel 62, with said end edge 933 define a ninth 90° fold line, and with said fold-in panel 872 extending from said fold-in panel 892 with said end edge 880 joined to said side edge 898 to define a second 180° fold line, and with said fold-in panel 892 extending from said fold-in panel 912 with said side edge 900 joined to said end edge 918 to define a fourth 180° fold line, and with said fold-in panel 912 extending from said fold-in panel 932 with said end edge 920 joined to said side edge 938 to define a sixth 180° fold line, and with said fold-in panel 932 extending from said sealing strip 154 with said side edge 940 joined to sealing strip 154 to define an eighth 180° fold line.

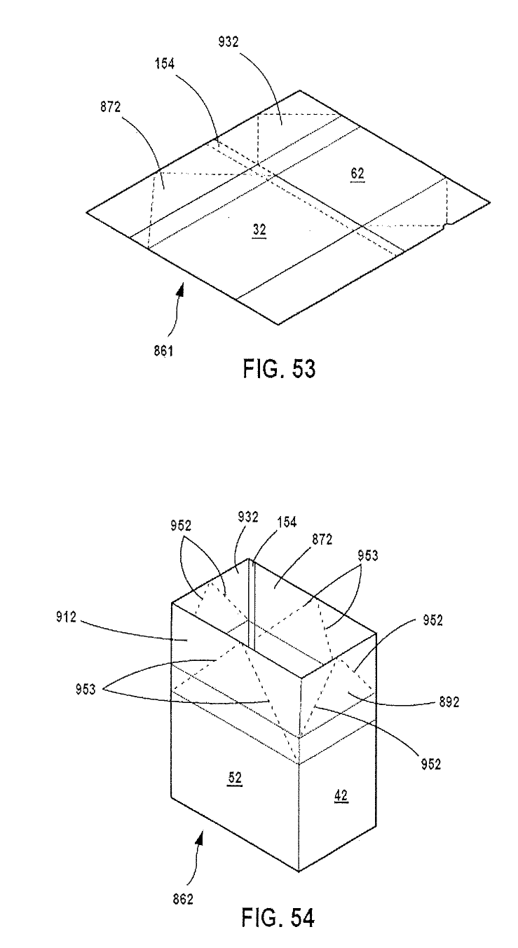

According to the present invention described herein and illustrated by accompanying drawing FIG. 53, improved carton flat 981 is formed from said improved carton blank 830 when carton blank 830 is folded and glued at said sealing strip 154, with said new top variable height continuous closure panel having said fold-in panel 932 joined to said fold-in panel 872 at said eighth 180° fold line.

According to the present invention described herein and illustrated by accompanying drawings FIGS. 50 and 54, said improved carton can be closed at its lower carton height by folding said top variable height continuous closure panel on said third and seventh, 90° fold lines defined by their respective edges, and lower 90° fold line 893 and 933, or said carton 862 can be closed at its higher carton height by folding said top variable height continuous closure panel on said fifth and ninth 90° fold lines defined by their respective edges and higher 90° fold line 874 and 914.

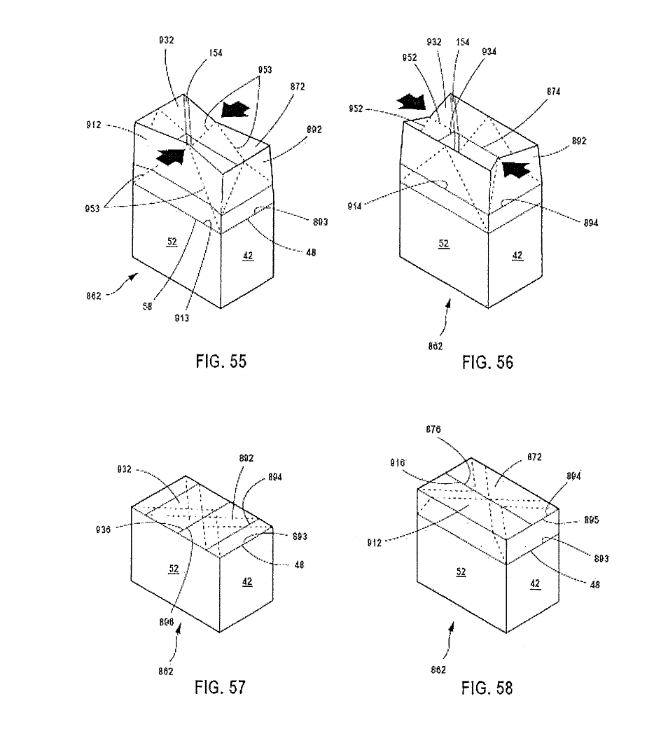

According to the present invention described herein and illustrated by accompanying drawings FIGS. 55 and 57, said improved carton 862 can be closed at its lower height when one or both said side fold-in panels 872 and 912 begin being pushed or pulled in a downward and inward direction, thereby causing said side fold-in panels 872 and 912 to begin folding in a downward and inward direction on said third and seventh 90° fold lines respective, while simultaneously folding on said transverse 180° fold lines 953, and simultaneously folding on said second, fourth, sixth, and eighth 180° fold lines, thereby also causing said end fold-in panels 892 and 932 to begin folding in a downward and inward direction on said lower 90° fold lines 893 and 933, respectively, and as one or both said end fold-in panels 892 and 932 are now pushed in a downward and inward direction, said end fold-in panels 892 and 932 continue folding in a downward and inward direction on said lower 90° fold lines 893 and 933, respectively, with said end fold-in panels 892 and 932 simultaneously folding over and on top of said side fold-in panels 872 and 912, and as said end fold-in panels 892 and 932 continue being pushed in a downward and inward direction, said side fold-in panels 872 and 912 completely fold over themselves on said transverse 180° fold lines 953 and on said second, fourth, sixth and eighth 180° fold lines until said second end edges 896 and 936 of said end fold-in panels 892 and 932 respectively meet to close said carton 862 at its lower height.

According to the present invention described herein and illustrated by accompanying drawings FIGS. 56 and 58, said improved carton 862 can be closed at its higher height when one or both said end fold-in panels 892 and 932 begin being pushed or pulled in a downward and inward direction, thereby causing said end fold-in panels 892 and 932 to begin folding in a downward and inward direction on said fifth and ninth 90° fold lines respectively, while simultaneously folding on said transverse 180° fold lines 952, and simultaneously folding on said second, fourth, sixth, and eighth 180° fold lines thereby also causing said side fold-in panels 872 and 912 to begin folding in a downward and inward direction on said higher 90° fold lines 874 and 914 respectively, and as one or both said side fold-in panels 872 and 912 are now pushed in a downward and inward direction, said side fold-in panels 872 and 912 continue folding in a downward and inward direction on said higher 90° fold lines 874 and 914 respectively, with said side fold-in panels 872 and 912 simultaneously folding over and on top of said end fold-in panels 892 and 932, and as said side fold-in panels 872 and 912 continue being pushed in a downward and inward direction, said end fold-in panels 892 and 932 completely fold over themselves on said transverse 180° fold lines 952 and on said second, fourth, sixth and eighth 180° fold lines until said second side edges 876 and 916 of said side fold-in panels 872 and 912 respectively meet to close said carton 862 at its higher height.

The third aspect (3) of the present invention has been described herein with reference to a preferred embodiment; however, rearrangements, alternations and substitutions can be made and still the result would be within the scope of the present invention. For example, instead of said improved carton blank 830 illustrated by FIG. 50 for forming an improved carton having a new top variable height continuous closure panel described herein regarding the present invention and having a bottom continuous closure panel as described in the aforementioned U.S. patents, a different improved carton blank can have said new top variable height continuous closure panel described herein regarding the third aspect (3) of the present invention and can have said new bottom Style A or B or C flexible continuous closure panels as described herein regarding the first aspect (1) of the present invention and as illustrated by accompanying drawing FIGS. 18, 27 and 32; or a different improved carton blank can have said new top variable height continuous closure panel described herein and can have said new bottom interlocking continuous closure panel as described herein regarding the second aspect (2) of the present invention and as illustrated by accompanying drawing FIG. 37; or a different improved carton blank can have said new top variable height continuous closure panel described herein and can have said new bottom continuous closure panel having features according to example embodiments of said improved fold-in panels of the third aspect of the present invention described herein.

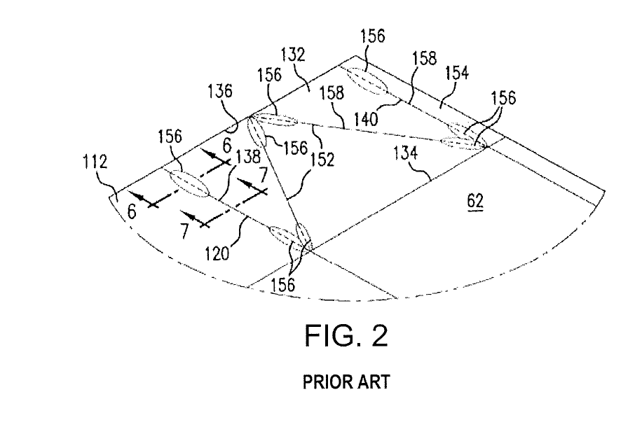

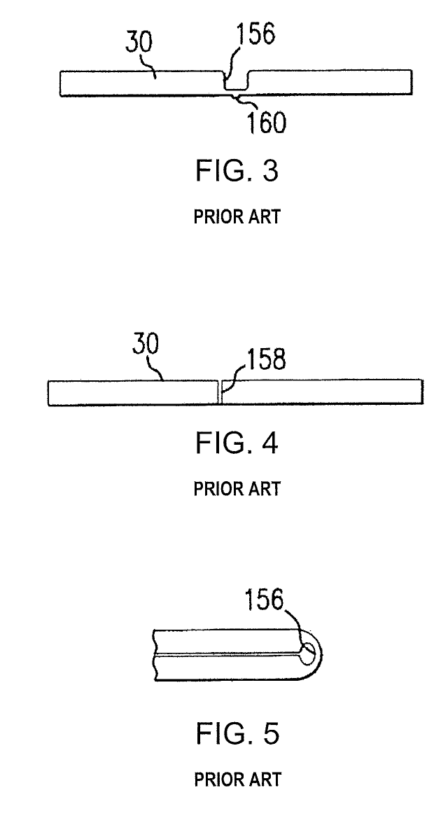

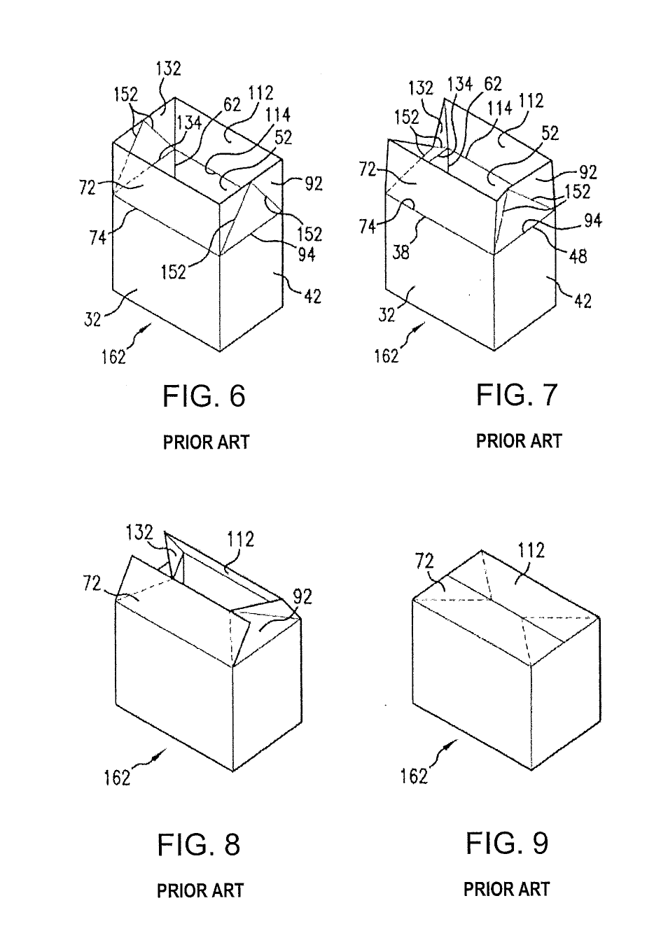

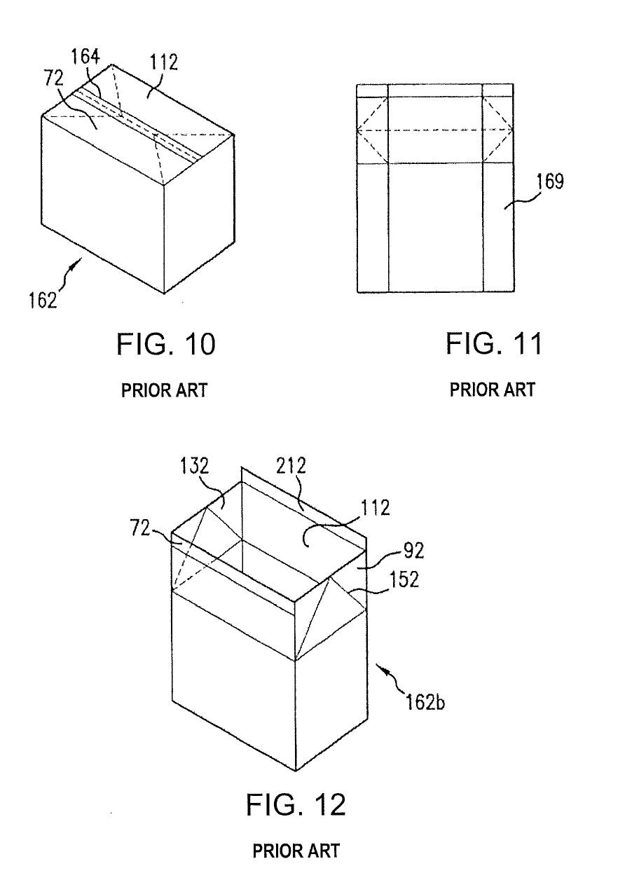

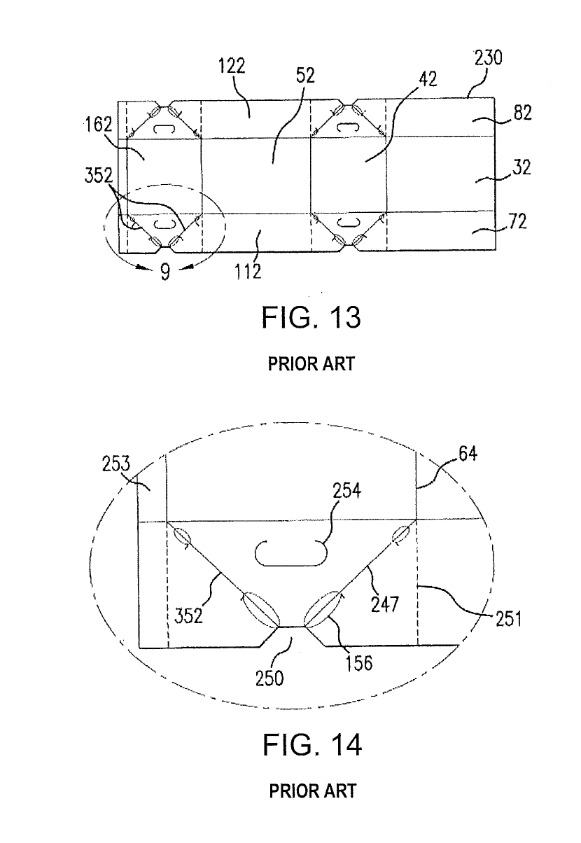

Each said transverse 180° fold lines 552, 752, 952 and 953 has been described herein with reference to a preferred embodiment; however, rearrangements, alternations and substitutions can be made and still the result would be within the scope of the present invention. For example, instead of said partially or fully incrementally cut fold lines and said compressed areas that extend partially or fully along one or both sides of said fold lines, the compressed areas 156 that are joined by a straight slit 158 are used, like those in the known blanks and cartons described above and illustrated in FIGS. 1-12 and in the aforesaid U.S. patents, different fold lines 552, 752, 952 and 953 can have a C-shaped cut 247 extending between the first and second compressed areas as described in the aforementioned U.S. patents, or different said transverse 180° fold lines 552, 752, 952 and 953 can have other shape cut, said new shapes having features according to example embodiments of said improved fold-in panels of the present invention described herein.

1. A blank for producing a carton wherein a continuous closure panel can flex, which permits carton stacking, said blank comprising:
a first side panel having substantially parallel first and second end edges and having substantially parallel top and bottom edges, with said top and bottom edges substantially perpendicular to said first and second end edges;
a first end panel having substantially parallel first and second side edges, with said first and second side edges substantially parallel with said first side panel second end edge, and with said first end panel having substantially parallel top and bottom edges, and with said top and bottom edges substantially perpendicular to said first and second side edges, and with said top edge being an extension of said first side panel top edge, and with said bottom edge being an extension of said first side panel bottom edge, wherein said first end panel extending from said first side panel and with said first end panel first side edge joining said first side panel second end edge to define a first 90° fold line;
a second side panel having substantially parallel first and second end edges, with said first and second end edges substantially parallel with said first end panel second side edge, and with said second side panel having substantially parallel top and bottom edges, and with said top and bottom edges substantially perpendicular to said first and second end edges, and with said top edge being an extension of said first end panel top edge, and with said bottom edge being an extension of said first end panel bottom edge, wherein said second side panel extending from said first end panel and with said second side panel first end edge joining said first end panel second side edge to define an eleventh 90° fold line;
a second end panel having substantially parallel first and second side edges, with said first and second side edges substantially parallel with said second side panel second end edge, and with said second end panel having substantially parallel top and bottom edges, and with said top and bottom edges substantially perpendicular to said first and second side edges, and with said top edge being an extension of said second side panel top edge, and with said bottom edge being an extension of said second side panel bottom edge, wherein said second end panel extending from said second side panel and with said second end panel first side edge joining said second side panel second end edge to define a second 90° fold line;
a first top panel having substantially parallel first and second end edges, with said first end edge being an extension of said first side panel first end edge, and with said second end edge being an extension of said first side panel second end edge, and with said first top panel having substantially parallel first and second side edges, and with said first and second side edges substantially parallel with said first side panel top edge, and with said first and second side edges substantially perpendicular to said first and second end edges, wherein said first top panel extending from said first side panel and with said first top panel first side edge joining the first side panel top edge to define a third 90° fold line;
a first bottom panel having substantially parallel first and second end edges, with said first end edge being an extension of said first side panel first end edge, and with said second end edge being an extension of said first side panel second end edge, and with said first bottom panel having substantially parallel first and second side edges, and with said first and second side edges substantially parallel with said first side panel bottom edge, and with said first and second side edges substantially perpendicular to said first and second end edges, wherein said first bottom panel extending from said first side panel and with said first bottom panel first side edge joining said first side panel bottom edge to define a fourth 90° fold line;
a first fold-in panel having substantially parallel first and second end edges, with said first end edge being an extension of said first top panel first side edge, and with said second end edge being the same length or shorter than said first end edge, and with said first and second end edges substantially parallel with said first end panel top edge, and with said first fold-in panel having first and second side edges, and with said second side edge substantially parallel with said first top panel second end edge, and with said second side edge substantially perpendicular to said first and second end edges, and with said second side edge being an extension of said first end panel second side edge, and with said first side edge extending from said first end edge at or adjacent said first top panel first side edge to said second end edge, wherein said first fold-in panel extending from said first end panel, and with said first fold-in panel first end edge joining said first end panel top edge to define a fifth 90° fold line;
a second fold-in panel having substantially parallel first and second end edges, with said first end edge being an extension of said first bottom panel first side edge, and with said second end edge being the same length or shorter than said first end edge, and with said first and second end edges substantially parallel with said first end panel bottom edge, and with said second fold-in panel having first and second side edges, and with said second side edge substantially parallel with said first bottom panel second end edge, and with said second side edge substantially perpendicular to said first and second end edges, and with said second side edge being an extension of said first end panel second side edge, and with said first side edge extending from said first end edge at or adjacent said first bottom panel first side edge to said second end edge, wherein said second fold-in panel extending from said first end panel, and with said second fold-in panel first end edge joining said first end panel bottom edge to define a sixth 90° fold line;
a second top panel having substantially parallel first and second end edges, with said first end edge being an extension of said second side panel first end edge, and with said second end edge being an extension of said second side panel second end edge, and with said first and second end edges substantially parallel with said first fold in panel second side edge, and with said second top panel having substantially parallel first and second side edges, and with said first and second side edges substantially parallel with said second side panel top edge, and with said first and second side edges substantially perpendicular to said first and second end edges, and with said first side edge being an extension of said first fold-in panel first end edge, and with said second side edge being an extension of said first fold-in panel second end edge, wherein said second top panel extending from said second side panel, and with said second top panel first side edge joining said second side panel top edge to define a seventh 90° fold line, and with said second top panel first end edge joining said first fold-in panel second side edge to define a 180° fold line;
a second bottom panel having substantially parallel first and second end edges, with said first end edge being an extension of said second side panel first end edge, and with said second end edge being an extension of said second side panel second end edge, and with said first and second end edges substantially parallel with said second fold in panel second side edge, and with said second bottom panel having substantially parallel first and second side edges, and with said first and second side edges substantially parallel with said second side panel bottom edge, and with said first and second side edges substantially perpendicular to said first and second end edges, and with said first side edge being an extension of said second fold-in panel first end edge, and with said second side edge being an extension of said second fold-in panel second end edge, wherein said second bottom panel extending from said second side panel and with said second bottom panel first side edge joining said second side panel bottom edge to define an eighth 90° fold line, and with said second bottom panel first end edge joining said second fold-in panel second side edge to define a 180° fold line;
a third fold-in panel having substantially parallel first and second end edges, with said first end edge being an extension of said second top panel first side edge, and with said second end edge being the same length or shorter than said first end edge, and with said first and second end edges substantially parallel with said second end panel top edge, and with said third fold-in panel having first and second side edges extending from said first end edge to said second edge, wherein said parallel first and second end edges and said first and second side edges create said third fold-in panel, wherein said third fold-in panel extending from said second end panel, with said third fold-in panel first end edge joining said second end panel top edge to define a ninth 90° fold line;
a fourth fold-in panel having substantially parallel first and second end edges, with said first end edge being an extension of said second bottom panel first side edge, and with said second end edge being the same length or shorter than said first end edge, and with said first and second end edges substantially parallel with said second end panel bottom edge, and with said fourth fold-in panel having first and second side edges extending from said first end edge to said second end edge, wherein said parallel first and second end edges and said first and second side edges create the fourth fold-in panel, wherein said fourth fold-in panel extends from said second end panel and with said fourth fold-in panel first end edge joining said second end panel bottom edge to define a tenth 90° fold line;
wherein the fold-in panels each have at least one transverse 180° fold line extending from a point at the intersection of the second side edge and the first end edge to a point at the second end edge of said, and wherein said at least one transverse 180° fold line of said fold-in panels includes at least one compressed area and a cut extending along at least a portion of the fold which are configured to allow the fold-in panel to flex outwardly and fold in each of opposite directions about the fold line.
wherein at least one of the first and third fold-in panels has a cut out extending from the fold-in panel second end edge to form a notch to provide a top flexible continuous closure panel which permits carton stacking.

2. The blank according to claim 1, wherein said first and second bottom panels and second and fourth fold-in panels have shaped cuts or shaped notches and locking edges formed thereon to provide an interlocking bottom continuous closure panel.

3. The blank according to claim 1, wherein said first top panel, first fold-in panel, second top panel, and third fold-in panel each have an additional 90° fold line substantially parallel to and spaced above respective ones of said third, fifth, seventh, and ninth 90° fold lines
wherein said first and second top panel each have at least one transverse 180° fold line extending from a point at the intersection of the second end edge and the first side edge to a point at the second side edge of said panels wherein said transverse 180° fold line of said fold-in panels includes at least one compressed area and a cut extending along a portion of the fold line to permit a carton erected to be closed to one of two different heights.

4. The blank according to claim 1, wherein both the first and third fold-in panels have a cut out extending from the fold-in panel second end edge to form a notch to provide the top flexible continuous closure panel.

5. The blank according to claim 4, wherein the cut out in the third fold-in panel is at one of the first and second side edges of the panel.

6. The blank according to claim 4, wherein the cut out of at least one of the first and third fold-in panels is intermediate to the first and second side edges to form two respective partial fold-in panels of the fold-in panel.

7. The blank according to claim 1, further comprising a glue tab joining the third fold-in panel second side edge to define a twelfth 90° fold line, and with said glue tab joining the fourth fold-in panel second side edge to define a 180° fold line.

8. The blank according to claim 1, wherein at least one of the second and fourth fold-in panels has a cut out extending from the fold-in panel second end edge to form a notch to provide a bottom flexible continuous closure panel which permits carton stacking when the carton is erected upside down.

9. The blank according to claim 1, wherein both the second and fourth fold-in panels have a cut out extending from the fold-in panel second end edge to form a notch to provide the bottom flexible continuous closure panel.

10. The blank according to claim 9, wherein the cut out in the fourth fold-in panel is at one of the first and second side edges of the panel.

11. The blank according to claim 9, wherein the cut out at least one of the second and fourth fold-in panels is intermediate to the first and second side edges to form two respective partial fold-in panels of the fold-in panel.

12. The blank according to claim 1, wherein said first bottom panel, second fold-in panel, second bottom panel, and fourth fold-in panel each have an additional 90° fold line substantially parallel to and spaced above respective ones of said fourth, sixth, eight, and tenth 90° fold lines wherein said first and second bottom panel each have at least one transverse 180° fold line extending from a point at the intersection of the second end edge and the first side edge to a point at the second side edge of said panels wherein said at least one transverse 180° fold line of said fold-in panels includes at least one compressed area and a cut extending along a portion of the fold line, to permit a carton to be erected to one of two different heights.

13. The blank according to claim 3, wherein the blank consists of a top variable height continuous closure panel having two side fold-in panels and two end fold-in panels.

14. The blank according to claim 12, wherein the blank consists of a bottom variable height continuous closure panel having two side fold-in panels and two end fold-in panels.

15. The blank according to claim 13, wherein the top continuous closure panel consists of two side fold-in panels and wherein the two end fold-in panels can be any type of panel or flap.

16. The blank according to claim 14, wherein the bottom continuous closure panel consists of two end fold-in panels and wherein the two side fold-in panels can be any type of panel or flap.

17. The blank according to claim 1, wherein the notched fold-in panels each have a trapezoidal or other shape.

18. The blank according to claim 17, wherein each fold-in panel includes a control notch on said fold-in panel's end edge located between the side edge of said fold-in panel and the end edge of the nearest top or bottom panel.

19. The blank according to claim 1, wherein each top fold-in panel first side edge joins the second end edge of the top panel respectively, thereby creating a continuous closure panel.

20. The blank according to claim 2, wherein the blank consists of a bottom interlocking continuous closure panel having two notched bottom fold-in panels and two notched bottom panels.

21. The blank according to claim 20, wherein each notched bottom fold-in panel has a trapezoidal or other shape edge.

22. The blank according to claim 20, wherein the notched bottom fold-in panel has one or more locking edge.

23. The blank according to claim 22, wherein each locking edge is a rounded or other shape.

24. The blank according to claim 2, wherein each bottom panel is made with or without a notch edge.

25. The blank according to claim 2, wherein the notched bottom panel has one or more notch edge.

26. The blank according to claim 25, wherein the notched bottom panel edge is one or two oval or other shapes that are partially or fully cut out of the notched bottom panel.

27. The blank according to claim 26, wherein the notch edge is a rounded or other shape.

28. The blank according to claim 1, wherein compressed area extending partially or fully along one or both sides of said fold lines permits reverse folding along each transverse 180° fold line.

29. A method of producing a carton blank from claim 1, wherein all edges, compressed areas, cuts, and creases can be created on a single side of the blank and still allow fold-in panels to fold in an inward direction, as well as to fold in an opposite outward direction.

30. A carton erected from the blank of claim 1.

31. The erected carton from claim 30, wherein such cartons in open condition can be stacked one inside the other.

32. A method of erecting the bottom of a folded and glued carton from claim 30, said method comprising placing said folded and glued carton so that said carton's bottom flexible continuous closure panel extends upwardly from said carton's first and second side surfaces and from first and second end surfaces, respectively, so that when said fold-in panels begin to fold inwardly, thereby causing said bottom panels simultaneously to begin to fold inwardly and continue to fold inwardly, thereby simultaneously causing said fold-in panels to close while said fold-in panels fold inwardly over themselves until the side edges of said bottom panels meet and until downward folding ceases on said bottom panels, thereby causing said bottom connected closure panels to be in closed, erected and square condition, and after securing said closed carton in closed condition by means of but not limited to tape or glue, said carton remains in closed and erected condition.

33. A method of closing an erected carton from claim 32 after said carton is erected, said method comprising placing said erected carton so that said carton's top flexible continuous closure panel extends upwardly from said carton's first and second side surfaces and from first and second end surfaces, respectively, so that when said fold-in panels begin to be folded inwardly, thereby causing said top panels to begin to fold simultaneously inwardly, said top panels continue to fold inwardly, thereby simultaneously causing said fold-in panels to close and said fold-in panels fold inwardly over themselves until the side edges of said top panels meet and until downward folding ceases on said top panels, thereby causing said top connected closure panels to be in closed and square condition, and after securing said carton in closed condition by means of but not limited to tape or glue, said carton remains in closed condition.

34. A method of stacking multiple cartons from claim 32, said method comprising inserting the closed bottom of an erected “carton 1” into the open top of another erected “carton 2,” such insertion of “1” into “2” causing the top connected closure panels of “2” to flex in an outward direction to allow the bottom of “1” to be inserted into “2,” thereby achieving the advantage of stacking previously erected and open cartons without limit as to the height of the stack.

35. A carton erected from the blank of claim 2, wherein such cartons once erected the bottom fold-in panels interlock with the bottom panels.

36. A method of erecting and interlocking the bottom of a folded and glued carton from claim 35, said method comprising placing said folded and glued carton so that said carton's first and second bottom panels and second and fourth fold-in panels extend upwardly from said carton's first and second side surfaces and from first and second end surfaces, respectively, so that when said fold-in panels begin to fold outwardly, thereby causing said bottom panels to begin to fold simultaneously inwardly, said fold-in panels continue to fold outwardly, thereby causing said bottom panels to close while said fold-in panels simultaneously fold outwardly over themselves, so that once said bottom panels are closed, said fold in-in panels now begin to fold upwardly and inwardly until said fold-in panels fold over the top of said bottom panels, and said fold-in panels continue to fold downwardly until the end edges of said fold-in panels lose contact with said bottom panels and until downward folding ceases on said fold-in panels, thereby allowing all said panels to spring upwardly, and said locking edges of fold-in panels to remain under said locking edges of the bottom panels, thereby causing said fold-in panels and said bottom panels to fully interlock together at the respective notches of said fold-in panels and said bottom panels, thereby causing said bottom continuous closure panel to be in closed condition and to remain in closed condition without need of taping, gluing, stapling or other assistance to remain in closed condition.

37. A carton according to any of claim 3, wherein said carton can be closed to any one of several heights.

38. A method of closing carton to any one of several heights according to claim 37, comprising placing the carton with said carton's first and second side fold-in panels and first and second end fold-in panels extending upwardly from said carton's first and second side surfaces and first and second end surfaces, respectively, so that said carton can be closed at its lowest height, said side fold-in panels are folded inwardly, thereby causing said end fold-in panels to simultaneously fold inwardly, so that when the partially closed end fold-in panels are folded downwardly, said carton's said side fold-in panels fold inwardly beneath said end fold-in panels, thereby closing said carton at its lowest height so that said carton can be closed at its highest height, said end fold-in panels are folded inwardly, thereby causing said side fold-in panels to simultaneously fold inwardly, so that when the partially closed side fold-in panels are folded downwardly, said carton's said end fold-in panels fold inwardly beneath said side fold-in panels, thereby closing said carton at its highest height.

39. The blank according to claim 1, wherein the blank is corrugated

40. The blank according to claim 1, further comprising a sealing strip for sealing the blank as a carton.
